(19) United States
(12) Patent Application Publication
(10) Pub. No.: US 2025/0159425 A1
(43) Pub. Date: May 15, 2025

(54) INFORMATION PROCESSING DEVICE, INFORMATION PROCESSING METHOD, AND RECORDING MEDIUM

(71) Applicant: Sony Group Corporation, Tokyo (JP)

(72) Inventors: Kentaro KIMURA, Tokyo (JP); Osamu SHIGETA, Tokyo (JP); Yu NISHIMURA, Tokyo (JP); Tsutomu FUZAWA, Tokyo (JP); Yuichi HASEGAWA, Tokyo (JP)

(73) Assignee: Sony Group Corporation, Tokyo (JP)

(21) Appl. No.: 18/839,439

(22) PCT Filed: Feb. 27, 2023
(86) PCT No.: PCT/JP2023/006962

§ 371 Date: Aug. 19, 2024

(30) Foreign Application Priority Data
Mar. 15, 2022 (JP) 2022-040383

(51) Int. Cl. H04S 7/00; H04N 7/18; H04N 23/698

(52) U.S. Cl. CPC H04S 7/303; H04N 7/183; H04N 23/698

(57) ABSTRACT

There is provided an information processing device, an information processing method, and a recording medium that enable sharing of attention of users existing in a wide area. The information processing device includes a control unit that performs control of spatial localization of an audio of another user except a target user on the basis of information regarding at least one of a view direction of a first user corresponding to a captured image captured by an imaging device provided for the first user or a view direction of a second user who views a surrounding captured image in which surroundings of a position where the first user exists are captured as the captured image. The present disclosure can be applied to, for example, devices constituting a system that shares view information.

### TECHNICAL FIELD

The present disclosure relates to an information processing device, an information processing method, and a recording medium, and particularly relates to an information processing device, an information processing method, and a recording medium that enable sharing of attention of users existing in a wide area.

### BACKGROUND ART

In recent years, in order to transmit an experience of a certain person to another person as it is, there has been proposed an interface that communicates with the another person by transmitting a first-person viewpoint image, and allows the another person to share the experience or asks for knowledge or instructions of the another person.

Furthermore, there is known a system in which a distributor distributes a wide area image from a local site in real time, and a plurality of viewers participating from remote locations can view the distributed wide area image (see, for example, Patent Document 1).

### CITATION LIST

### Patent Document

Patent Document 1: International Publication No. 2015/122108

### SUMMARY OF THE INVENTION

### Problems to be Solved by the Invention

By the way, in the above-described system, since directions that the respective users are viewing in the wide area image are different, it is sometimes difficult to transmit attention of a certain person to others, and a technique for sharing the attention of the users existing in the wide area has been required.

The present disclosure has been made in view of such circumstances, and enables sharing of attention of users existing in a wide area.

### Solutions to Problems

An information processing device according to one aspect of the present disclosure is an information processing device including: a control unit configured to perform control of spatial localization of an audio of another user except a target user on the basis of information regarding at least one of a view direction of a first user corresponding to a captured image captured by an imaging device provided for the first user or a view direction of a second user who views a surrounding captured image in which surroundings of a position where the first user exists are captured as the captured image.

An information processing method and a recording medium according to one aspect of the present disclosure are an information processing method and a recording medium corresponding to the information processing device according to one aspect of the present disclosure.

The information processing device, the information processing method, and the recording medium according to one aspect of the present disclosure perform the control of spatial localization of an audio of another user except a target user on the basis of information regarding at least one of a view direction of a first user corresponding to a captured image captured by an imaging device provided for the first user or a view direction of a second user who views a surrounding captured image in which surroundings of a position where the first user exists are captured as the captured image.

Note that the information processing device according to one aspect of the present disclosure may be an independent device or an internal block constituting one device.

### BRIEF DESCRIPTION OF DRAWINGS

FIG. 1 is a diagram illustrating an outline of a view information sharing system to which the present disclosure is applied.

FIG. 2 is a diagram schematically illustrating a one-to-N network topology.

FIG. 3 is a diagram schematically illustrating an N-to-one network topology.

FIG. 4 is a diagram schematically illustrating an N-to-N network topology.

FIG. 5 is a block diagram illustrating a functional configuration example of a distribution device and a viewing device in FIG. 1.

FIG. 6 is a block diagram illustrating another example of functional configurations of the distribution device and the viewing device in FIG. 1.

FIG. 7 is a diagram illustrating an example of spatial localization of an audio according to a view direction of each user.

FIG. 8 is a diagram illustrating an example of changing a display area in the spatial localization of the audio according to the view direction of each user.

FIG. 9 is a flowchart for describing a flow of processing of synchronizing coordinates of respective users (Body and Ghost) of images and audios.

FIG. 10 is a flowchart for describing a flow of processing of synchronizing coordinates of respective users (Ghost1 and Ghost2) of images and audios.

FIG. 11 is a diagram illustrating an example of control of spatial localization of an audio of each user in a case where a plurality of users participates.

FIG. 12 is a diagram illustrating an example of initial alignment using an indicator of an image.

FIG. 13 is a diagram illustrating an example of control of spatial localization of an audio according to depth of what each user is viewing.

FIG. 14 is a flowchart illustrating a flow of processing including attention point specification using audio recognition and fixation of an audio localization direction.

FIG. 15 is a diagram illustrating an example of specification of an attention point.

FIG. 16 is a diagram illustrating an example of audio adjustment according to a situation.

FIG. 17 is a diagram illustrating a configuration example of an audio output unit.

FIG. 18 is a diagram illustrating an example of an angular difference θ of an audio with respect to a front of a user.

FIG. 19 is a graph illustrating a relationship between an importance I and the angular difference θ of the audio.

FIG. 20 is a graph illustrating a relationship between a gain A of a sound pressure amplifier and the importance I of the audio.

FIG. 21 is a graph illustrating a relationship between a gain E_{A} of an EQ filter and the importance I of the audio.

FIG. 22 is a graph illustrating a relationship between a ratio R of reverb and the importance I of the audio.

FIG. 23 is a diagram illustrating an example of a method of presenting a line-of-sight guidance sound.

FIG. 24 is a diagram illustrating a specific example of presentation of the line-of-sight guidance sound.

FIG. 25 is a diagram illustrating an example of control in a depth direction of audio localization according to priority.

FIG. 26 is a diagram illustrating an example of a method of setting the priority.

FIG. 27 is a diagram illustrating an example in which a localization space of an audio is divided for each specific group.

FIG. 28 is a block diagram showing a configuration example of hardware of a computer.

### MODE FOR CARRYING OUT THE INVENTION

### First Embodiment

### <Configuration of System>

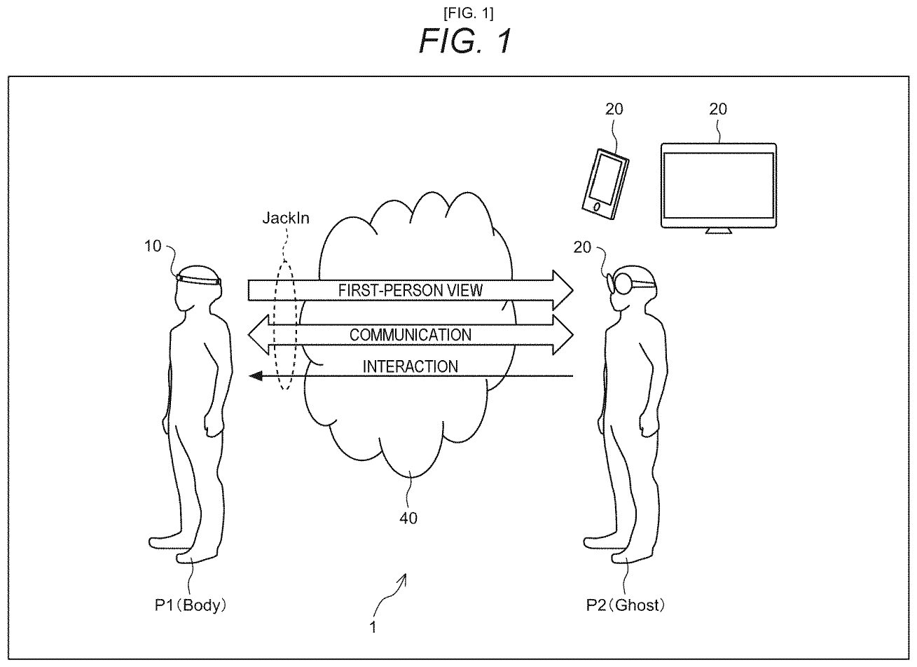

FIG. 1 is a diagram illustrating an outline of a view information sharing system to which the present disclosure is applied.

In FIG. 1, a view information sharing system 1 includes a distribution device 10 that distributes a captured image obtained by capturing an image of a site, and a viewing device 20 that views an image distributed from the distribution device 10. The system refers to a logical assembly of a plurality of devices.

The distribution device 10 is, for example, a device worn on the head or the like by a distributor P1 who is actually present and active on the site, and includes an imaging device (camera) capable of capturing an ultra-wide-angle or omnidirectional image.

The viewing device 20 is configured as, for example, a head mounted display (HMD) worn on the head of a viewer P2 who is not at the site and views (watches) the captured image. For example, when an immersive HMD is used as the viewing device 20, the viewer P2 can more realistically experience a same scene as the distributor P1, but a see-through HMD may be used.

The viewing device 20 is not limited to the HMD, and may be, for example, a wristwatch-type display. Alternatively, the viewing device 20 does not need to be a wearable terminal, and may be a multifunctional information terminal such as a smartphone or a tablet terminal, a computer screen including a personal computer (PC) or the like, a general monitor display such as a television receiver, a game machine, a projector that projects an image on a screen, or the like.

The viewing device 20 is arranged at the site, that is, separated from the distribution device 10. For example, the distribution device 10 and the viewing device 20 communicate with each other via a network 40. The network 40 includes, for example, a communication network such as the Internet, an intranet, and a mobile phone network, and enables mutual connection between devices by various wired or wireless networks. Note that the term “separated” as used herein includes not only a remote location but also a situation where the device is slightly (for example, about several meters) away in a same room.

The distributor P1 is also referred to as a “Body” below because the distributor P1 actually exists on the site and is active by his/her body. In contrast, the viewer P2 is not active with his/her body on site, but is conscious of the site by viewing a first-person view (FPV) of the distributor P1, and thus is referred to as a “Ghost” below. Hereinafter, the distribution device 10 worn by the distributor P1 may be referred to as the “Body”, and the viewing device 20 worn by the viewer P2 may be referred to as the “Ghost”. Moreover, since the distributor P1 (Body) and the viewer P2 (Ghost) can be said to be users of the system, the distributor P1 (Body) and the viewer P2 (Ghost) may be referred to as “users P”.

The Body can transmit its surrounding situation to the Ghost and further share the surrounding situation with the Ghost. Meanwhile, the Ghost communicates with the Body and can implement interaction such as work support from a separated place. In the view information sharing system 1, the Ghost performing interaction while being immersed in a first-person experience of the Body is also referred to as “JackIn”.

The view information sharing system 1 has basic functions to transmit a first-person view from the Body to the Ghost, view and experience the view on a Ghost side as well, and perform communication between the Body and the Ghost. By using the latter communication function, the Ghost can implement interaction with the Body by intervention from the remote location such as “field of view intervention” of intervening in a field of view of the Body, “hearing intervention” of intervening in hearing of the Body, “body intervention” of operating or stimulating the body or a part of the body of the Body, and “alternative conversation” that the Ghost talks on the site instead of the Body.

For the sake of simplicity, FIG. 1 illustrates a network topology in which only one distribution device 10 and one viewing device 20 exist, and Body and Ghost are on a one-to-one basis, but other network topologies can be applied.

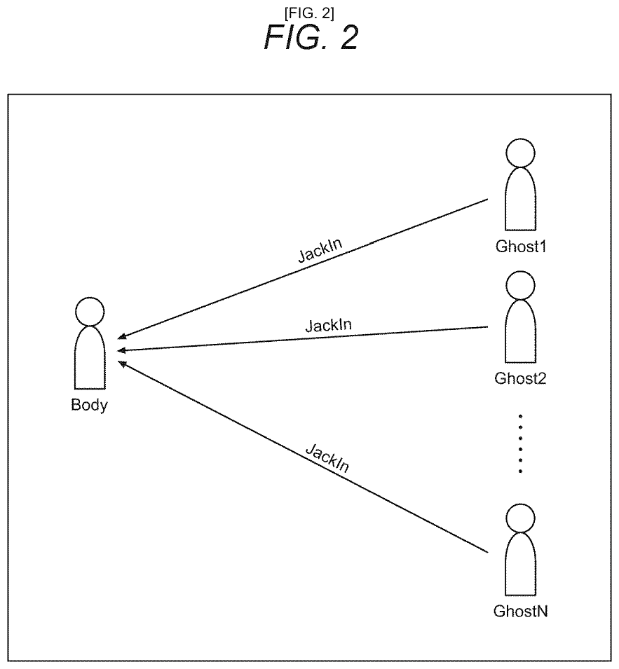

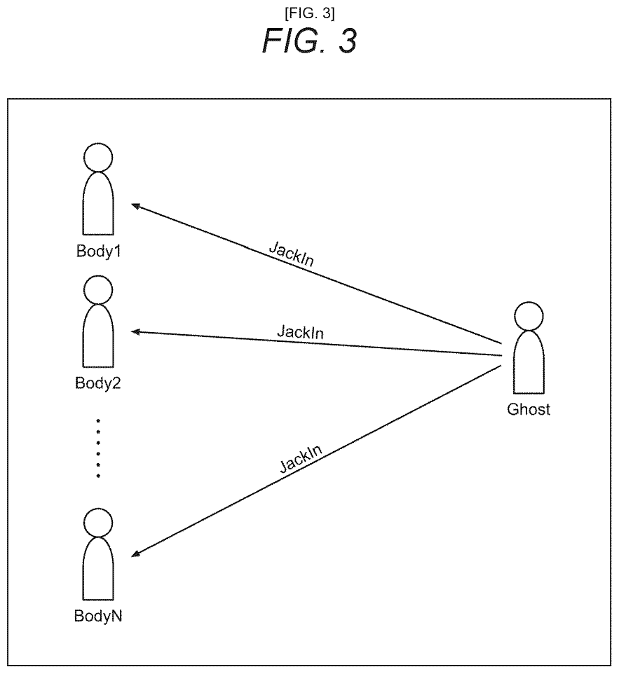

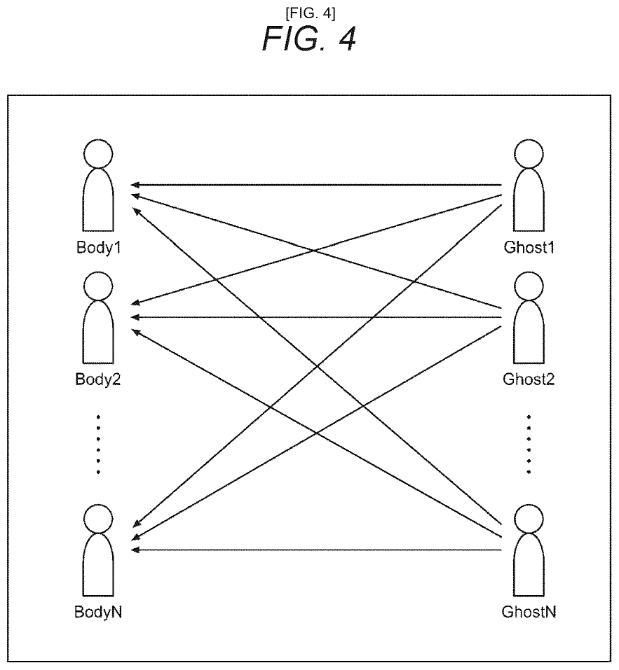

For example, as illustrated in FIG. 2, a one-to-N network topology in which one Body and a plurality of (N) Ghosts perform JackIn at the same time may be applied. Alternatively, an N-to-one network topology in which a plurality of (N) Bodies and one Ghost perform JackIn at the same time as illustrated in FIG. 3, or an N-to-N network topology in which a plurality of (N) Bodies and a plurality of (N) Ghosts perform JackIn at the same time as illustrated in FIG. 4 may be applied.

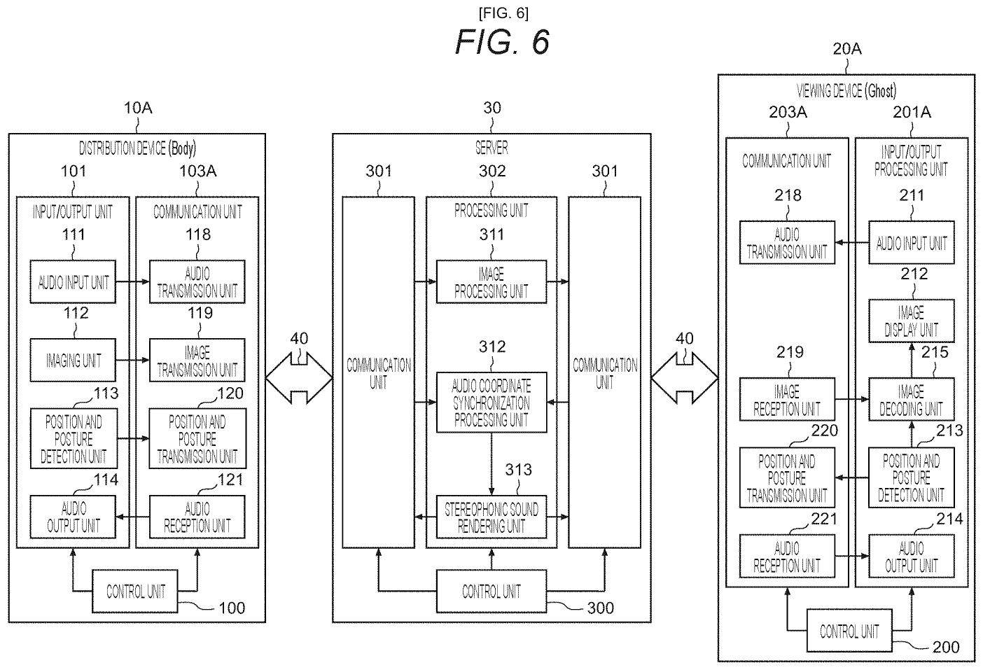

Furthermore, it is also assumed that one device is switched from the Body to the Ghost, or conversely from the Ghost to the Body, or one device has roles of the Body and the Ghost at the same time. A network topology (not illustrated) in which three or more devices are daisy-chained is also assumed, in which one device performs JackIn as the Ghost to a certain Body, and functions as a Body for another Ghost at the same time. Although details will be described below, in any network topology, a server (server 30 in FIG. 6 to be described below) may be interposed between the distribution device 10 (Body) and the viewing device 20 (Ghost).

### <Functional Configuration of Device>

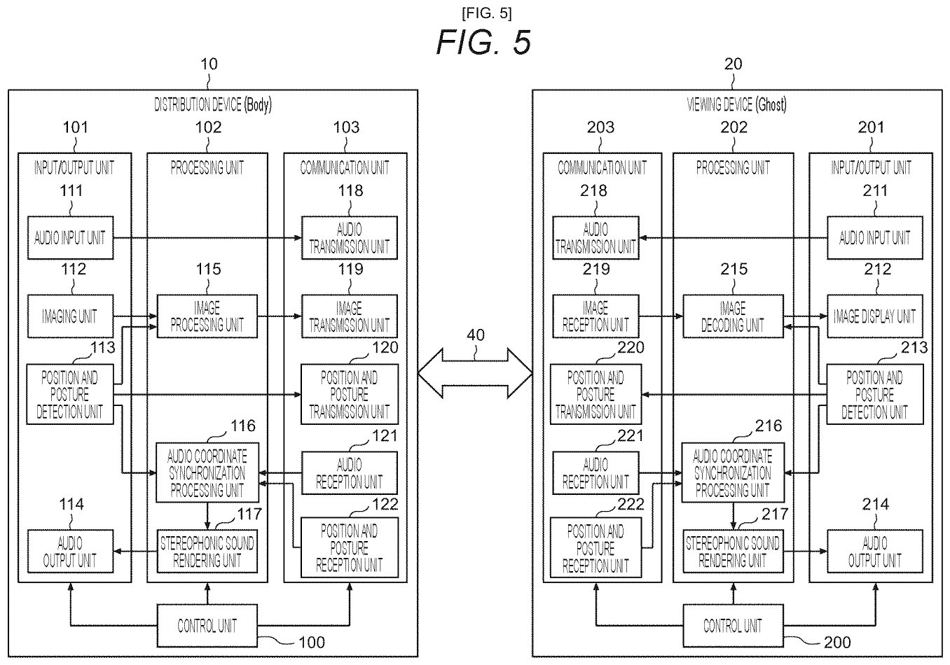

FIG. 5 is a block diagram illustrating a functional configuration example of the distribution device 10 and the viewing device 20 in FIG. 1. The distribution device 10 and the viewing device 20 are examples of an information processing device to which the present disclosure is applied.

In FIG. 5, the distribution device 10 includes a control unit 100, an input/output unit 101, a processing unit 102, and a communication unit 103. The control unit 100 includes a processor such as a central processing unit (CPU). The control unit 100 controls operations of the input/output unit 101, the processing unit 102, and the communication unit 103. The input/output unit 101 includes various input devices, output devices, and the like. The communication unit 103 includes a communication circuit or the like.

The input/output unit 101 includes an audio input unit 111, an imaging unit 112, a position and posture detection unit 113, and an audio output unit 114. The processing unit 102 includes an image processing unit 115, an audio coordinate synchronization processing unit 116, and a stereophonic sound rendering unit 117. The communication unit 103 includes an audio transmission unit 118, an image transmission unit 119, a position and posture transmission unit 120, an audio reception unit 121, and a position and posture reception unit 122.

The audio input unit 111 includes a microphone or the like. The audio input unit 111 collects an audio of the distributor P1 (Body) and supplies an audio signal to the audio transmission unit 118. The audio transmission unit 118 transmits the audio signal from the audio input unit 111 to the viewing device 20 via the network 40.

The imaging unit 112 includes an imaging device (camera) including an optical system such as a lens, an image sensor, a signal processing circuit, and the like. The imaging unit 112 captures an image of a real space to generate an image signal, and supplies the image signal to the image processing unit 115. For example, the imaging unit 112 can generate an image signal of a surrounding captured image in which surroundings of a position where the distributor P1 (Body) exists are captured by an omnidirectional camera (360-degree camera). The surrounding captured image includes, for example, an omnidirectional image or an ultra-wide-angle image of the surroundings of 360 degrees, and the following description exemplifies the omnidirectional image.

The position and posture detection unit 113 includes, for example, various sensors such as an acceleration sensor, a gyro sensor, and an inertial measurement unit (IMU). The position and posture detection unit 113 detects, for example, a position and a posture of the head of the distributor P1 (Body), and supplies resultant position and posture information (for example, a rotation amount of the Body) to the image processing unit 115, the audio coordinate synchronization processing unit 116, and the position and posture transmission unit 120.

The image processing unit 115 applies image processing to the image signal from the imaging unit 112, and supplies a resultant image signal to the image transmission unit 119. For example, the image processing unit 115 rotationally corrects the omnidirectional image captured by the imaging unit 112 on the basis of the position and posture information (for example, the rotation amount of the Body) detected by the position and posture detection unit 113. The image transmission unit 119 transmits the image signal from the image processing unit 115 to the viewing device 20 via the network 40.

The position and posture transmission unit 120 transmits the position and posture information from the position and posture detection unit 113 to the viewing device 20 via the network 40. The audio reception unit 121 receives the audio signal (for example, an audio of the Ghost) from the viewing device 20 via the network 40, and supplies the audio signal to the audio coordinate synchronization processing unit 116. The position and posture reception unit 122 receives position and posture information (for example, a rotation amount of the Ghost) from the viewing device 20 via the network 40, and supplies the position and posture information to the audio coordinate synchronization processing unit 116.

The position and posture information from the position and posture detection unit 113, the audio signal from the audio reception unit 121, and the position and posture information from the position and posture reception unit 122 are supplied to the audio coordinate synchronization processing unit 116. The audio coordinate synchronization processing unit 116 performs processing for synchronizing coordinates of the audio of the viewer P2 (Ghost) for the audio signal on the basis of the position and posture information, and supplies a resultant audio signal to the stereophonic sound rendering unit 117. For example, the audio coordinate synchronization processing unit 116 rotationally corrects the audio of the viewer P2 (Ghost) on the basis of the position and posture information (for example, the rotation amount of the Body or the rotation amount of the Ghost).

The stereophonic sound rendering unit 117 performs stereophonic sound rendering for the audio signal from the audio coordinate synchronization processing unit 116, and allows the audio of the viewer P2 (Ghost) to be output as a stereophonic sound from the audio output unit 114. The audio output unit 114 includes, for example, headphones, earphones, or the like. For example, in a case where the audio output unit 114 includes headphones, stereophonic sound generation is performed according to acoustic characteristics for each headphones, such as headphone inverse characteristics, and transmission characteristics to the user's ears.

In FIG. 5, the viewing device 20 includes a control unit 200, an input/output unit 201, a processing unit 202, and a communication unit 203. The control unit 200 includes a processor such as a CPU. The control unit 200 controls operations of the input/output unit 201, the processing unit 202, and the communication unit 203. The input/output unit 201 includes various input devices, output devices, and the like. The communication unit 203 includes a communication circuit or the like.

The input/output unit 201 includes an audio input unit 211, an image display unit 212, a position and posture detection unit 213, and an audio output unit 214. The processing unit 202 includes an image decoding unit 215, an audio coordinate synchronization processing unit 216, and a stereophonic sound rendering unit 217. The communication unit 203 includes an audio transmission unit 218, an image reception unit 219, a position and posture transmission unit 220, an audio reception unit 221, and a position and posture reception unit 222.

The audio input unit 211 includes a microphone or the like. The audio input unit 211 collects the audio of the viewer P2 (Ghost) and supplies the audio signal to the audio transmission unit 218. The audio transmission unit 218 transmits the audio signal from the audio input unit 211 to the distribution device 10 via the network 40.

The image reception unit 219 receives the image signal from the distribution device 10 via the network 40, and supplies the image signal to the image decoding unit 215. The image decoding unit 215 applies decoding processing to the image signal from the image reception unit 219, and displays a resultant image corresponding to the image signal on the image display unit 212. For example, the image decoding unit 215 rotates a display area in the omnidirectional image received by the image reception unit 219 on the basis of the position and posture information (for example, the rotation amount of the Ghost) detected by the position and posture detection unit 213 so as to be displayed on the image display unit 212. The image display unit 212 includes a display or the like.

The position and posture detection unit 213 includes, for example, various sensors such as an IMU. The position and posture detection unit 213 detects, for example, the position and posture of the head of the viewer P2 (Ghost), and supplies the resultant position and posture information (for example, the rotation amount of the Ghost) to the image decoding unit 215, the audio coordinate synchronization processing unit 216, and the position and posture transmission unit 220. For example, in a case where the viewing device 20 is an HMD, a smartphone, or the like, the rotation amount can be acquired by the IMU. Furthermore, in a case where the viewing device 20 is a PC or the like, the rotation amount can be acquired from movement of drag of a mouse.

The position and posture transmission unit 220 transmits the position and posture information from the position and posture detection unit 213 to the distribution device 10 via the network 40. The audio reception unit 221 receives the audio signal (for example, the audio of the Body) from the distribution device 10 via the network 40, and supplies the audio signal to the audio coordinate synchronization processing unit 216. The position and posture reception unit 222 receives the position and posture information (for example, the rotation amount of the Body) from the distribution device 10 via the network 40, and supplies the position and posture information to the audio coordinate synchronization processing unit 216.

The position and posture information from the position and posture detection unit 213, the audio signal from the audio reception unit 221, and the position and posture information from the position and posture reception unit 222 are supplied to the audio coordinate synchronization processing unit 216. The audio coordinate synchronization processing unit 216 performs processing for synchronizing the coordinates of the audio of the distributor P1 (Body) for the audio signal on the basis of the position and posture information, and supplies the resultant audio signal to the stereophonic sound rendering unit 217. For example, the audio coordinate synchronization processing unit 216 rotationally corrects the audio of the distributor P1 (Body) on the basis of the position and posture information (for example, the rotation amount of the Body or the rotation amount of the Ghost).

The stereophonic sound rendering unit 217 performs stereophonic sound rendering for the audio signal from the audio coordinate synchronization processing unit 216, and allows the audio of the distributor P1 (Body) to be output as a stereophonic sound from the audio output unit 214. The audio output unit 214 includes, for example, headphones, earphones, a speaker, or the like. For example, in a case where the audio output unit 214 includes headphones, stereophonic sound generation is performed according to acoustic characteristics for each headphones, such as headphone inverse characteristics, and transmission characteristics to the user's ears. Furthermore, in a case where the audio output unit 214 includes a speaker, stereophonic sound generation is performed according to the number and arrangement of the speakers.

Although the configuration in which the distribution device 10 and the viewing device 20 communicate with each other via the network 40 has been described, the functions of the processing unit 102 and the processing unit 202 in FIG. 5 may be transferred to the server 30 side by interposing the server 30 such as a cloud server between the distribution device 10 and the viewing device 20, as illustrated in FIG. 6. As a result, a distribution device 10A and a viewing device 20A in FIG. 6 are adaptable even if those devices are non-powerful computing resources. The server 30 is an example of an information processing device to which the present disclosure is applied.

In FIG. 6, the distribution device 10A includes the input/output unit 101 and a communication unit 103A, and is not provided with the processing unit 102, as compared with the distribution device 10 in FIG. 5. The input/output unit 101 is configured similarly to that of FIG. 5, but the communication unit 103A does not need to receive the position and posture information from the viewing device 20A and thus does not include the position and posture reception unit 122.

The audio transmission unit 118 and the position and posture transmission unit 120 are configured similarly to those in FIG. 5, and transmit the audio signal and the position and posture information to the server 30 via the network 40. The image transmission unit 119 transmits the image signal from the imaging unit 112 to the server 30. The audio reception unit 121 receives the audio signal to which the stereophonic sound rendering has been applied from the server 30 via the network 40, and the audio of the viewer P2 (Ghost) is output as a stereophonic sound from the audio output unit 114.

In FIG. 6, the viewing device 20A includes an input/output processing unit 201A and a communication unit 203A, and is not provided with the processing unit 102, but an image decoding unit 215 is provided in the input/output processing unit 201A, as compared with the viewing device 20 in FIG. 5. The input/output processing unit 201A is configured similarly to that of FIG. 5 except that the image decoding unit 215 is added, but the communication unit 203A does not include the position and posture reception unit 222 since reception of the position and posture information from the distribution device 10A is not necessary.

The audio transmission unit 218 and the position and posture transmission unit 220 are configured similarly to those in FIG. 5, and transmit the audio signal and the position and posture information to the server 30 via the network 40. The image reception unit 219 is configured similarly to that of FIG. 5, and receives the image signal from the server 30 via the network 40 and supplies the image signal to the image decoding unit 215. The audio reception unit 221 receives the audio signal to which the stereophonic sound rendering has been applied from the server 30 via the network 40, and the audio of the distributor P1 (Body) is output as a stereophonic sound from the audio output unit 214.

In FIG. 6, the server 30 includes a control unit 300, a communication unit 301, and a processing unit 302. The control unit 300 includes a processor such as a CPU. The control unit 300 controls operations of the communication unit 301 and the processing unit 302. The communication unit 301 includes a communication circuit or the like. The processing unit 302 includes an image processing unit 311, an audio coordinate synchronization processing unit 312, and a stereophonic sound rendering unit 313.

The image signal and the position and posture information received by the communication unit 301 from the distribution device 10A via the network 40 are supplied to the image processing unit 311. The image processing unit 311 has a function similar to the image processing unit 115 in FIG. 5, and applies image processing to the image signal on the basis of the position and posture information and supplies a resultant image signal to the communication unit 301. The communication unit 301 transmits the image signal from the image processing unit 311 to the viewing device 20A via the network 40.

The position and posture information received from the distribution device 10A and the audio signal and the position and posture information received from the viewing device 20A by the communication unit 301 via the network 40 are supplied to the audio coordinate synchronization processing unit 312. The audio coordinate synchronization processing unit 312 performs processing for synchronizing the coordinates of the audio of the viewer P2 (Ghost) (for example, rotation correction of the audio of the Ghost) for the audio signal on the basis of the position and posture information (for example, the rotation amount of the Body or the rotation amount of the Ghost), and supplies a resultant audio signal to the stereophonic sound rendering unit 313.

Then, the stereophonic sound rendering unit 313 performs stereophonic sound rendering for the audio signal from the audio coordinate synchronization processing unit 312, and allows the audio of the viewer P2 (Ghost) to be output as a stereophonic sound from the audio output unit 114 of the distribution device 10A. The communication unit 301 transmits the audio signal from the stereophonic sound rendering unit 313 to the distribution device 10A via the network 40.

Furthermore, the audio signal and the position and posture information received from the distribution device 10A and the position and posture information received from the viewing device 20A by the communication unit 301 via the network 40 are supplied to the audio coordinate synchronization processing unit 312. The audio coordinate synchronization processing unit 312 performs processing for synchronizing the coordinates of the audio of the distributor P1 (Body) (for example, rotation correction of the audio of the Body) for the audio signal on the basis of the position and posture information (for example, the rotation amount of the Body or the rotation amount of the Ghost), and supplies a resultant audio signal to the stereophonic sound rendering unit 313.

Then, the stereophonic sound rendering unit 313 performs stereophonic sound rendering for the audio signal from the audio coordinate synchronization processing unit 312, and allows the audio of the distributor P1 (Body) to be output as a stereophonic sound from the audio output unit 214 of the viewing device 20A. The communication unit 301 transmits the audio signal from the stereophonic sound rendering unit 313 to the viewing device 20A via the network 40.

Note that although FIG. 6 illustrates a configuration in which both the function of the processing unit 102 of the distribution device 10 in FIG. 5 and the function of the processing unit 202 of the viewing device 20 in FIG. 5 are transferred to the processing unit 302 of the server 30, either one of the functions may be transferred. That is, in FIG. 6, the distribution device 10 of FIG. 5 may be provided instead of the distribution device 10A, or the viewing device 20 of FIG. 5 may be provided instead of the viewing device 20A. Moreover, the processing unit 302 of the server 30 is not limited to have the configuration having all the functions of the image processing unit, the audio coordinate synchronization processing unit, and the stereophonic sound rendering unit, and for example, may have a configuration to which only the function of the image processing unit is transferred or a configuration to which only the functions of the audio coordinate synchronization processing unit and the stereophonic sound rendering unit are transferred.

### <Spatial Localization of Audio According to View Direction of Each User>

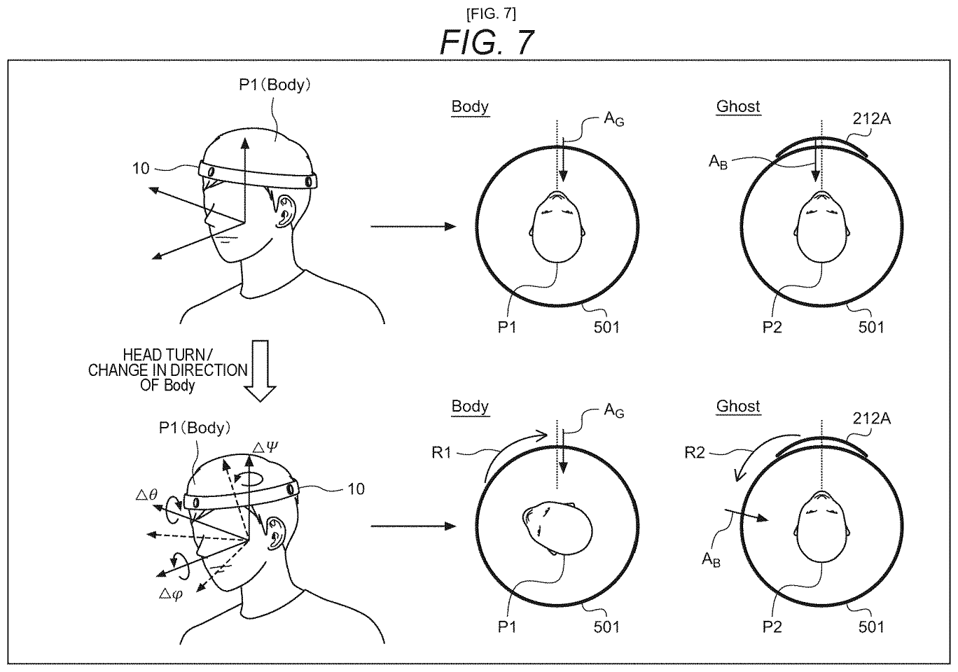

The distribution device 10 and the viewing device 20 can control spatial localization (audio localization) of the audio (sound image) of each user according to the view direction of each user to implement a stereophonic sound. FIG. 7 is a diagram illustrating an example of the spatial localization of the audio according to the view direction of each user.

FIG. 7 illustrates top views illustrating respective states of the distributor P1 (Body) and the viewer P2 (Ghost) before and after an action when the distributor P1 (Body) performs the action such as head turn or a change in direction. The top views of the Body and the Ghost in the upper part illustrate the state before the Body turns the head, and the top views of the Body and the Ghost in the lower part illustrate the state after the Body turns the head.

As illustrated in the top views in the upper part of FIG. 7, both the distributor P1 (Body) and the viewer P2 (Ghost) in an omnidirectional image 501 face the front before the distributor P1 (Body) turns the head. At this time, the distributor P1 hears the audio of the viewer P2 from a direction of the arrow A_{G} in front. Meanwhile, the viewer P2 hears the audio from the distributor P1 from a direction of the arrow A_{B} in front.

That is, the distributor P1 and the viewer P2 hear the mutual audios from the front. Furthermore, a display area 212A indicates a display area in the image display unit 212 of the viewing device 20, and the viewer P2 can view an area corresponding to the display area 212A in the omnidirectional image 501.

As illustrated in the top views in the lower part of FIG. 7, the direction in which the distributor P1 (Body) faces is not the front and a rotation amount (Δθ, Δφ, Δψ) is acquired after the distributor P1 (Body) turns the head. A rotational motion generated in the distribution device 10 or the viewing device 20 can be expressed using rotational coordinate axes defined independently of one another, such as a roll axis, a pitch axis, and a yaw axis, for example.

On the Body side, the omnidirectional image 501 is rotationally corrected (−Δθ, −Δφ, −Δψ) in a direction of offset indicated by the arrow R1 in accordance with the rotation amount of the head turn of the distributor P1. Therefore, the image is fixed regardless of the head turn of the distributor P1, and the omnidirectional image 501 after the rotation correction is distributed from the Body side to the Ghost side. Furthermore, on the Body side, the audio localization of the viewer P2 (Ghost) is rotationally corrected (−Δθ, −Δφ, −Δψ) in the direction of offset indicated by the arrow R1 in accordance with the rotation amount of the head turn of the distributor P1. Therefore, the distributor P1 (Body) can hear the audio of the viewer P2 (Ghost) from a right side direction indicated by the direction of the arrow A_{G}.

Meanwhile, on the Ghost side, the area in the view direction in the omnidirectional image 501 distributed from the Body side is displayed in the display area 212A. The omnidirectional image 501 is an image subjected to rotation correction on the Body side. Furthermore, on the Ghost side, the audio localization of the distributor P1 (Body) is rotationally corrected (Δθ, Δφ, Δψ) in the direction indicated by the arrow R2 in accordance with the rotation amount of the head turn of the distributor P1. Therefore, the viewer P2 (Ghost) can hear the audio of the distributor P1 (Body) from a left side direction indicated by the direction of the arrow A_{B}.

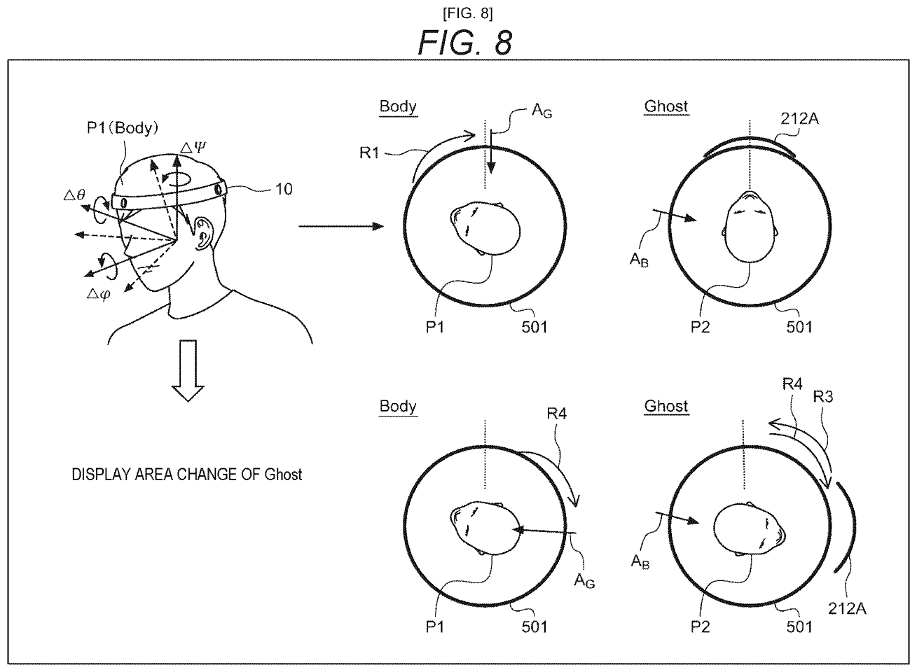

FIG. 8 illustrates a state of a case where the display area 212A is further changed by the action of the viewer P2 (Ghost) thereafter. This change of the display area 212A is performed by an action of the viewer P2 such as head turn or a change in direction in a case where the viewing device 20 is an HMD, or by a mouse operation or the like of the viewer P2 in a case of a PC, for example.

In FIG. 8, the top views of the Body and the Ghost in the upper part illustrate a state after the distributor P1 (Body) turns the head. That is, the top views of the Body and the Ghost in the upper part of FIG. 8 correspond to the top views of the Body and the Ghost in the lower part of FIG. 7, and the distributor P1 hears the audio of the viewer P2 from the right side direction while the viewer P2 hears the audio of the distributor P1 from the left side direction.

The top views of the Body and the Ghost in the lower part of FIG. 8 illustrate a state after the display area 212A on the Ghost side is changed. As illustrated in the top views of the Body and the Ghost in the lower part of FIG. 8, when the display area 212A on the Ghost side is rotated in the direction indicated by the arrow R4, the rotation amount (Δθ′, Δφ′, Δψ′) of the rotation is acquired.

On the Ghost side, the audio localization of the distributor P1 (Body) is rotationally corrected (−Δθ′, −Δφ′, −Δψ′) in the direction of offset indicated by the arrow R3 in accordance with the rotation amount of the display area 212A. Therefore, the viewer P2 (Ghost) can hear the audio of the distributor P1 (Body) from a rear side direction indicated by the direction of the arrow A_{B}.

On the other hand, on the Body side, the audio localization of the viewer P2 (Ghost) is rotationally corrected (Δθ′, Δφ′, Δψ′) in the direction indicated by the arrow R4 in accordance with the change in the display area 212A on the Ghost side. Therefore, the distributor P1 (Body) can hear the audio of the viewer P2 (Ghost) from the rear side direction indicated by the direction of the arrow A_{G}.

As described above, when a change in the view direction of the distributor P1 (Body) or the viewer P2 (Ghost) performing JackIn is detected, the spatial localization of the audios of the viewer P2 (Ghost) and the distributor P1 (Body) is controlled according to the detected change in the view direction, and the coordinates of the respective users (Body and Ghost) of the images and the audios can be synchronized.

### <Flow of Processing of Each Device>

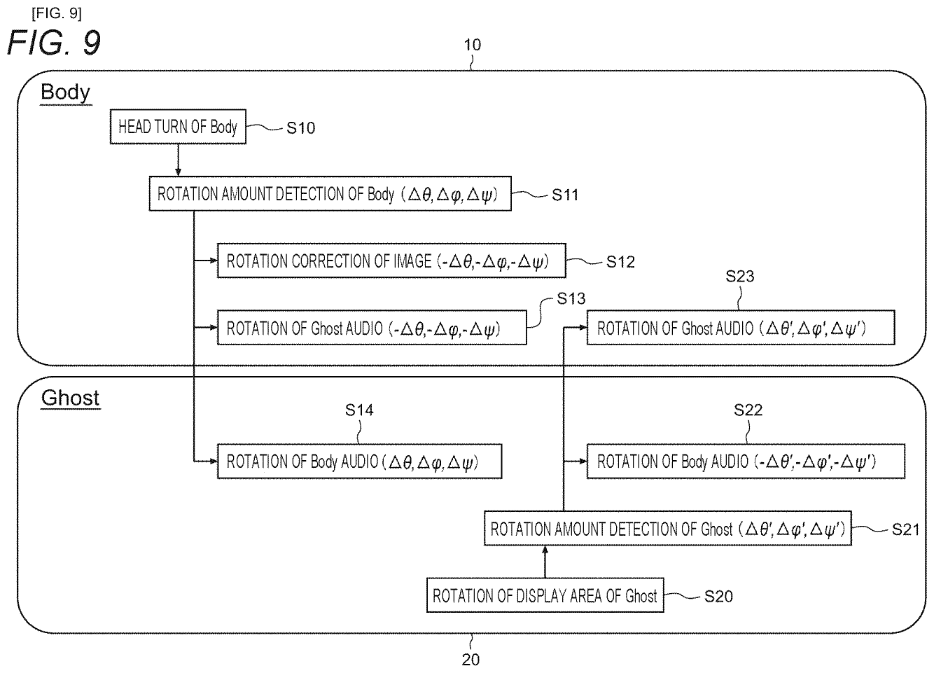

Next, a flow of the processing of synchronizing the coordinates of the respective users (Body and Ghost) of the images and audios will be described with reference to the flowchart of FIG. 9.

First, the synchronization processing in the case where the distributor P1 (Body) turns the head will be described. When the distributor P1 (Body) turns the head (S10), the processing of steps S11 to S13 is executed in the distribution device 10, and the processing of step S14 is executed in the viewing device 20.

In step S11, the position and posture detection unit 113 detects the rotation amount (Δθ, Δφ, Δψ) of the Body. The rotation amount of the Body is transmitted to the viewing device 20 via the network 40.

In step S12, the image processing unit 115 performs rotation correction (−Δθ, −Δφ, −Δψ) of the omnidirectional image on the basis of the rotation amount of the Body. The rotation-corrected omnidirectional image is transmitted to the viewing device 20 via the network 40.

In step S13, the audio coordinate synchronization processing unit 116 rotates (−Δθ, −Δφ, −Δψ) the audio of the Ghost received from the viewing device 20 on the basis of the rotation amount of the Body. Therefore, in the distribution device 10, the spatial localization of the audio of the Ghost is controlled so that the coordinates of the omnidirectional image and the audio of the Ghost are synchronized, and the audio is output as a stereophonic sound.

In step S14, the audio coordinate synchronization processing unit 216 rotates (Δθ, Δφ, Δψ) the audio of the Body received from the distribution device 10 on the basis of the rotation amount of the Body received from the distribution device 10. Therefore, in the viewing device 20, the spatial localization of the audio of the Body is controlled so that the coordinates of the omnidirectional image and the audio of the Body are synchronized, and the audio is output as a stereophonic sound.

By executing the processing of steps S11 to S14 in the distribution device 10 and the viewing device 20, for example, the Body hears the audio of the Ghost from the right side direction, and the Ghost hears the audio of the Body from the left side direction when the Body turns the head, as illustrated in the top views of the lower part of FIG. 7. Furthermore, as illustrated in the lower part of FIG. 7, the omnidirectional image after the rotation correction is distributed from the Body side to the Ghost side and displayed in the display area 212A.

Next, the synchronization process in the case where the display area of the viewer P2 (Ghost) is changed will be described. When the display area 212A of the viewer P2 (Ghost) rotates (S20), the processing of steps S21 to S22 is executed in the viewing device 20, and the processing of step S23 is executed in the distribution device 10.

In step S21, the position and posture detection unit 213 detects the rotation amount (Δθ′, Δφ′, Δψ′) of the Ghost. The rotation amount of the Ghost is transmitted to the distribution device 10 via the network 40.

In step S22, the audio coordinate synchronization processing unit 216 rotates (−Δθ′, −Δφ′, −Δψ′) the audio of the Body received from the distribution device 10 on the basis of the rotation amount of the Ghost. Therefore, in the viewing device 20, the spatial localization of the audio of the Body is controlled so that the coordinates of the omnidirectional image and the audio of the Body are synchronized, and the audio is output as a stereophonic sound.

In step S23, the audio coordinate synchronization processing unit 116 rotates (Δθ′, Δφ′, Δψ′) the audio of Ghost received from the viewing device 20 on the basis of the rotation amount of Ghost received from the viewing device 20. Therefore, in the distribution device 10, the spatial localization of the audio of the Ghost is controlled so that the coordinates of the omnidirectional image and the audio of the Ghost are synchronized, and the audio is output as a stereophonic sound.

By executing the processing of steps S21 to S23 in the distribution device 10 and the viewing device 20, for example, the Ghost hears the audio of the Body from the rear side direction, and the Body hears the audio of the Ghost from the rear side direction when the display area of the Ghost is changed, as illustrated in the top views of the lower part of FIG. 8.

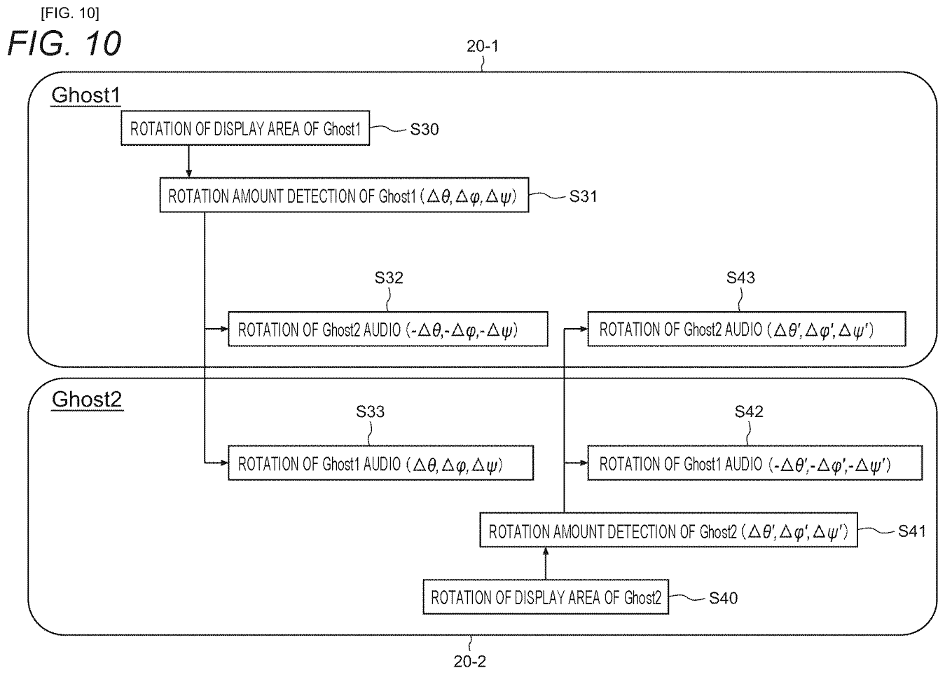

In the above description, processing between the Body and the Ghost has been described, but similar processing is performed between a plurality of Ghosts except for image processing. The flowchart in FIG. 10 illustrates a flow of the processing of synchronizing the coordinates of the respective users (Ghost1 and Ghost2) of the images and audios. In FIG. 10, for convenience of description, the description will be given on the premise that the Ghost1 uses a viewing device 20-1 and the Ghost2 uses a viewing device 20-2.

First, synchronization processing in a case where the display area of Ghost1 is changed will be described. When the display area 212A of the Ghost1 rotates (S30), the processing in steps S31 to S32 is executed in the viewing device 20-1, and the processing in step S33 is executed in the viewing device 20-2.

In step S31, the position and posture detection unit 213 of the viewing device 20-1 detects the rotation amount (Δθ, Δφ, Δψ) of the Ghost1. The rotation amount of Ghost1 is transmitted to the viewing device 20-2 via the network 40.

In step S32, the audio coordinate synchronization processing unit 216 of the viewing device 20-1 rotates (−Δθ, −Δφ, −Δψ) the audio of Ghost2 received from the viewing device 20-2 on the basis of the rotation amount of Ghost1. Therefore, in the viewing device 20-1, the spatial localization of the audio of the Ghost2 is controlled so that the coordinates of the omnidirectional image and the audio of the Ghost2 are synchronized, and the audio is output as a stereophonic sound.

In step S33, the audio coordinate synchronization processing unit 216 of the viewing device 20-2 rotates (Δθ, Δφ, Δψ) the audio of Ghost1 received from the viewing device 20-1 on the basis of the rotation amount of Ghost1 received from the viewing device 20-1. Therefore, in the viewing device 20-2, the spatial localization of the audio of the Ghost is controlled so that the coordinates of the omnidirectional image and the audio of the Ghost1 are synchronized, and the audio is output as a stereophonic sound.

Next, synchronization processing in a case where the display area of Ghost2 is changed will be described. When the display area 212A of the Ghost2 rotates (S40), the processing of steps S41 to S42 is executed in the viewing device 20-2, and the processing of step S43 is executed in the viewing device 20-1.

In step S41, the position and posture detection unit 213 of the viewing device 20-2 detects the rotation amount (Δθ′, Δφ′, Δψ′) of the Ghost2. The rotation amount of Ghost2 is transmitted to the viewing device 20-1 via the network 40.

In step S42, the audio coordinate synchronization processing unit 216 of the viewing device 20-2 rotates (−Δθ′, −Δφ′, −Δψ′) the audio of Ghost1 received from the viewing device 20-1 on the basis of the rotation amount of Ghost2. Therefore, in the viewing device 20-2, the spatial localization of the audio of the Ghost1 is controlled so that the coordinates of the omnidirectional image and the audio of the Ghost1 are synchronized, and the audio is output as a stereophonic sound.

In step S43, the audio coordinate synchronization processing unit 216 of the viewing device 20-1 rotates (Δθ′, Δφ′, Δψ′) the audio of Ghost2 received from the viewing device 20-2 on the basis of the rotation amount of Ghost2 received from the viewing device 20-2. Therefore, in the viewing device 20-1, the spatial localization of the audio of the Ghost2 is controlled so that the coordinates of the omnidirectional image and the audio of the Ghost2 are synchronized, and the audio is output as a stereophonic sound.

As described above, the distribution device 10 or the viewing device 20 controls the spatial localization of the audio of another user (Body or Ghost) except for the target user (Ghost or Body) on the basis of the information (rotation amount of Body or Ghost) regarding at least one of the view direction of the first user (Body) moving in the real space or the view direction of the second user (Ghost) who views the surrounding captured image (omnidirectional image) in which the surroundings of the position where the first user exists is captured as the captured image by the imaging device (the imaging unit 112) provided for the first user.

As a result, it is possible to localize the audio in conjunction with the surrounding captured image (omnidirectional image) by utilizing the stereophonic sound, and it is possible to share the attention of the users (Body and Ghost) existing in a wide area. Each user (Body or Ghost) only needs to wear minimum equipment such as headphones or earphones as an audio output unit and a microphone as an audio input unit, and it is possible to reduce the equipment in size and weight, and implement the system at a lower cost.

### <Control in a Case Where a Plurality of Users Participates>

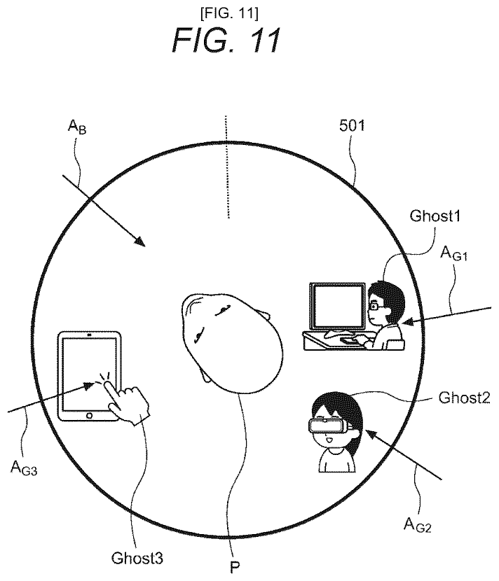

FIG. 11 is a diagram illustrating an example of control of the spatial localization of the audio of each user in a case where a plurality of users (Body and Ghost) participates. In FIG. 11, in addition to the user P, a Body and three Ghosts Ghost1 to Ghost3 participate in JackIn. In FIG. 11, the Ghost1 uses a PC, the Ghost2 uses an HMD, and the Ghost3 uses a smartphone.

Even in such a situation where a plurality of users participates, the image displayed in the display area 212A of each Ghost is fixed by moving the omnidirectional image 501 in the direction of offset according to the rotation amount of the Body, as described in FIG. 7 and the like. Furthermore, as described in FIG. 7 and the like, the spatial localization of the audio of each user is controlled in the Body and the Ghost in response to the rotation amount of each user.

As a result, it is possible to output the audio from the direction of the place viewed by each user in the omnidirectional image 501. For example, in FIG. 11, the user P hears the audio of the Body from the direction of the arrow A_{B} corresponding to the place that the Body is viewing. Furthermore, the user P hears the audio of the Ghost1 from the direction of the arrow A_{G1} corresponding to the place viewed by the Ghost1. Similarly, the user P hears the audio of the Ghost2 from the direction of the arrow A_{G2} corresponding to the place viewed by the Ghost2 and the audio of the Ghost3 from the direction of the arrow A_{G3} corresponding to the place viewed at by the Ghost3.

As described above, since it is possible to output the audio from the direction corresponding to the place viewed by each user, it is possible to guide a traveling direction of the Body, the direction of attention of each user, and the line-of-sight of the Body or another Ghost, for example.

Note that FIG. 11 illustrates a top view similarly to FIG. 7 and the like, and is adaptable to a head turn direction of the user P as well as being adaptable in an omnidirectional manner. For example, it is also adaptable to a front-back direction and a neck turn direction of the neck of the user P. The same similarly applies to the other users (Body and Ghost). For example, in a case where the Body or another Ghost is looking down, the spatial localization of the audio is controlled so that the audio of the Body or the another Ghost is output from a lower direction for the user P.

Here, in order to implement the control in the case where a plurality of users participates illustrated in FIG. 11, it is necessary to share the coordinate positions of the respective users (Body and Ghost), and initial alignment is performed when each user participates in JackIn. As a method of initial alignment, for example, any one of the following three methods can be used.

First, it is a method of performing initial alignment by unifying a position at the moment of entry, such as a position when each user logs in to the system, to a predetermined position such as the front, for example. Second, it is a method of performing initial alignment by specifying a coordinate position of each user using image processing such as collation of image feature amounts.

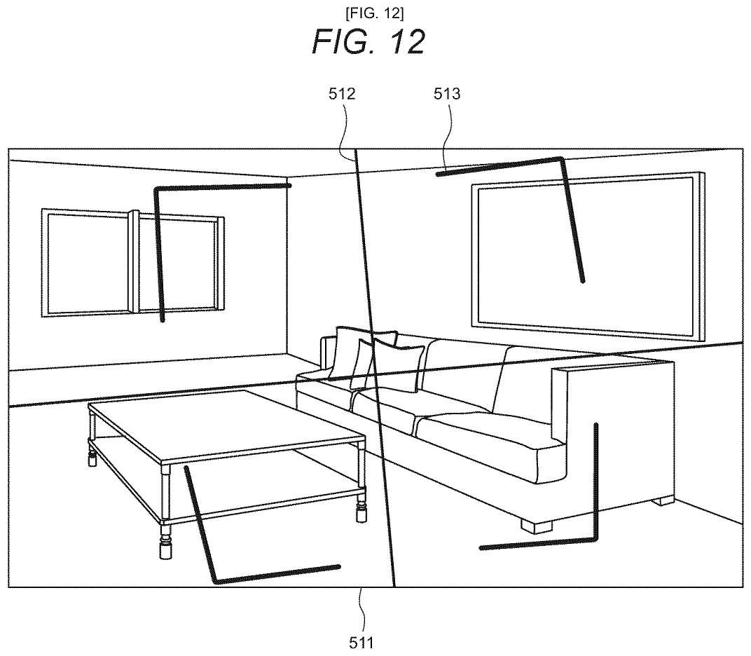

Third, it is a method of performing initial alignment by aligning indicators in front of an image sent from the Body on the Ghost side. For example, as illustrated in FIG. 12, in the viewing device 20, the initial alignment is performed by the viewer P2 (Ghost) manually aligning indicators 512 and 513 in front of an image 511 displayed on the image display unit 212.

### <Control of Depth Direction of Audio Localization>

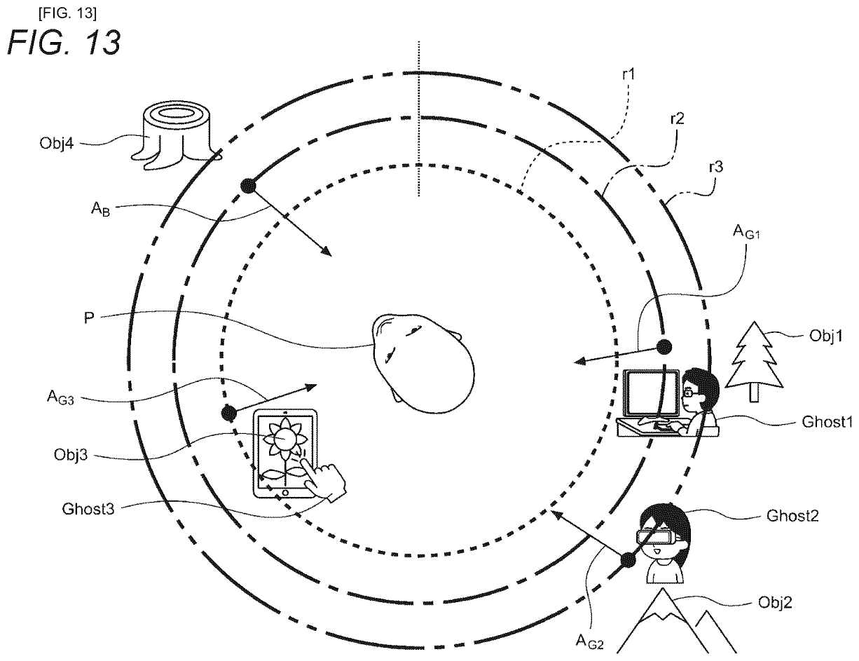

FIG. 13 is a diagram illustrating an example of control of spatial localization (audio localization) of an audio according to depth of what each user is viewing. In FIG. 13, similarly to FIG. 11, Ghost1 using a PC, Ghost2 using an HMD, and Ghost3 using a smartphone participate in addition to the user P.

In FIG. 13, three circles having different line types represent depth distances in the omnidirectional image 501. The dashed circle represents a distance r1, a one-dot chain-line circle represents a distance r2, a two-dot chain-line circle represents a distance r3, and a relationship of r1<r2<r3 is established.

An object Obj3 such as a flower exists on the distance r1, objects Obj1 and Obj4 such as trees and stumps exist on the distance r2, and an object Obj2 such as a mountain exists on the distance r3. At this time, the Ghost1 views the object Obj1, the Ghost2 views the object Obj2, and the Ghost3 views the object Obj3.

In such a situation, the audio localization of each user is controlled to be localized and changed in the depth direction according to not only the audio that is output from the direction of the place viewed by each user, but also the depth distance of what (object) each user is viewing.

For example, in a case where the depth distances among the object Obj1 viewed by the Ghost1, the object Obj2 viewed by the Ghost2, and the object Obj3 viewed by the Ghost3 are compared, the closest object is the object Obj3, the next closest object is the object Obj1, and the farthest object is the object Obj2.

At this time, in outputting the audio from the place of the object viewed by each Ghost, the audio of the Ghost3 from the direction of the arrow A_{G3} corresponding to the object Obj3 is set to be heard from a closer place, and the audio of the Ghost2 from the direction of the arrow A_{G2} corresponding to the object Obj2 is set to be heard from a farther place. Furthermore, the audio of the Ghost1 from the direction of the arrow A_{G1} corresponding to the object Obj1 is set to be heard from a middle of the audio of the Ghost3 and the audio of the Ghost2. Note that not only the audio of the Ghost but also the audio of the Body can be similarly controlled.

Here, in order to implement the control of the depth direction of the audio localization illustrated in FIG. 13, it is necessary to acquire information indicating the depth direction of the omnidirectional image and to specify what the user is viewing from the front of the Body or the Ghost display area. For example, the following methods can be used.

That is, as a method of acquiring the information indicating the depth direction of the omnidirectional image, there is a method of estimating depth information from the omnidirectional image using a learned model generated by machine learning. Alternatively, a method of providing sensors such as a depth sensor and a distance measuring sensor in a camera system of the Body, and acquiring the information indicating the depth direction from outputs of these sensors may be adopted. A method of performing self-position estimation or environmental map creation using a simultaneous localization and mapping (SLAM) technology and estimating a distance from a self-position or an environmental map may be adopted. A method of providing a function for tracking the line-of-sight of the Body and estimating the depth from stay and the distance of the line-of-sight may be adopted.

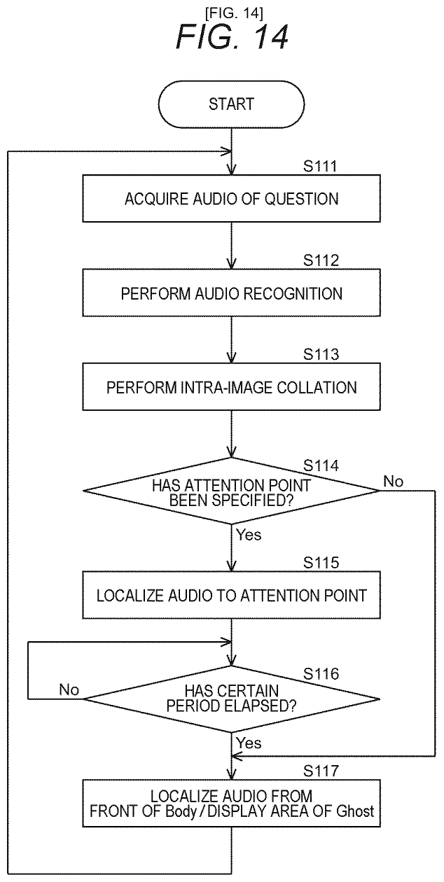

Furthermore, as a method of specifying what the user is viewing, there is a method of averaging the depth distances in the Ghost display area in whole or using the depth distance of t a center point in the Ghost display area. Alternatively, a method of providing a function to track the line-of-sight of the user and specifying what the user is viewing from the position where the line-of-sight is staying may be adopted. Furthermore, a method of specifying what the user is viewing using audio recognition may be adopted. Here, a flow of processing including attention point specification using audio recognition and fixation of an audio localization direction will be described with reference to a flowchart of FIG. 14.

For example, when a question “What is this blue book?” is asked by the viewer P2 (Ghost) who is a question person, the audio of the question is acquired (S111), the audio recognition is performed for the audio of the question (S112), and the question about “blue book” is recognized. Then, intra-image collation in the omnidirectional image is performed (S113), and it is determined whether or not the attention point of the viewer P2 (Ghost) can be specified on the basis of a collation result (S114).

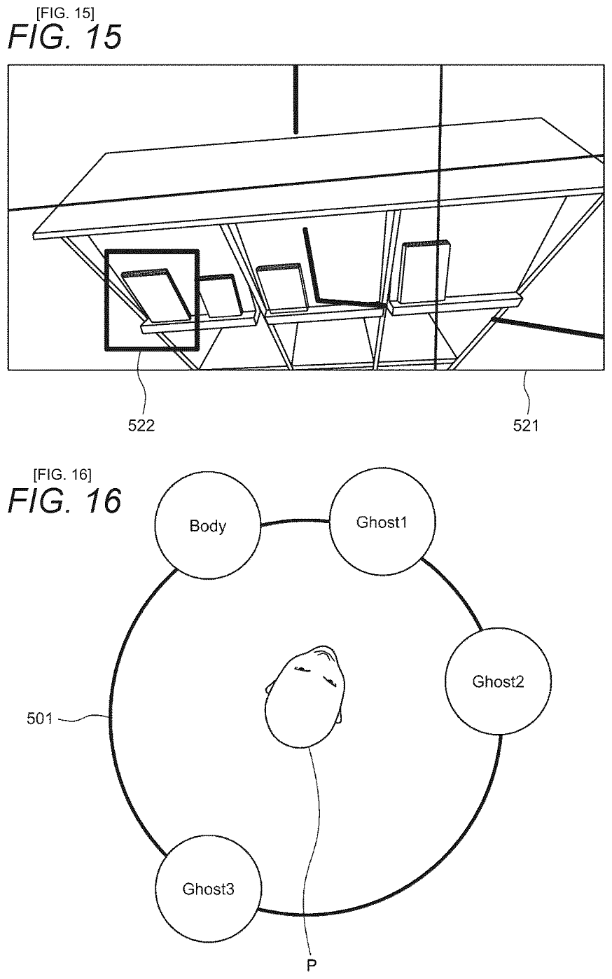

Here, since the question about “blue book” has been made, in a case where the “blue book” exists in an image 521 displayed on the image display unit 212, an area 522 including the “blue book” is specified as the attention point, as illustrated in FIG. 15. In a case where it is determined that the attention point can be specified in the determination processing of step S114 (“Yes” in S114), the audio of the viewer P2 (Ghost) is spatially localized at the specified attention point (S115).

Thereafter, the localization direction of the audio (sound image) is fixed to the attention point until a certain period of time elapses, and when the certain period of time elapses (“Yes” in S116), the processing proceeds to step S117. Furthermore, in a case where it is determined that the attention point cannot be specified in the determination processing of step S114 (“No” of S114), the processing of steps S115 to S116 is skipped, and the processing proceeds to step S117. Then, the audio of the viewer P2 (Ghost) is spatially localized from the front of the Body or the Ghost display area (S117). When the processing in step S117 ends, the procedure returns to step S111, and the subsequent processing is repeated.

For example, there is a possibility that the audio wobbles when conveying the attention point, or the audio is output from a place different from the attention point originally desired to be heard due to movement of the distributor P1 (Body) or the fact that the display area 212A of the viewer P2 (Ghost) is not always stable. Therefore, here, the attention point is specified using the audio recognition, and the direction of the spatial localization of the audio is fixed to the attention point in a certain period.

Note that, in FIG. 14, the audio recognition is used to specify the attention point, but a function to track the user's line-of-sight may be provided and the stay of the line-of-sight may be utilized. The processing illustrated in FIG. 14 can be executed by the control unit 100 (or the processing unit 102) of the distribution device 10 or the control unit 200 (or the processing unit 202) of the viewing device 20.

### Second Embodiment

In a case where there are sounds such as a plurality of audios and environmental sound, it may be difficult to hear the audio to be heard. By spatially localizing each audio using stereophonic sound, it is possible to distinguish and listen to a desired audio, but there are still cases where it is insufficient.

For example, such cases include when a distributor P1 (Body) is in a quiet place such as a museum, when the distributor P1 (Body) is in a noisy place such as a highway, when the number of participating viewers P2 (Ghost) is ten or more, when the number of audios is large, or when conversations between the viewers P2 (Ghost) are excited, or the like.

Furthermore, there is also a demand for listening in a state where the user can understand contents by focusing on the contents, such as the user noticing a matter of interest or hearing a matter that is related to the user, even when they hear sounds other than the audio that the user wants to concentratedly listen to. That is, in a case where only an audio in the direction in which the user wants to listen is set to be heard, the user cannot hear other audios or cannot understand what is said even if the user wants to listen to the other audios.

Therefore, hereinafter, in order to solve the above problem and facilitate interaction between users such as the distributor P1 (Body) and the viewer P2 (Ghost), and the viewer P2 (Ghost1) and the viewer P2 (Ghost2), processing of adjusting the audio of the user on the basis of the relationship between the participating users, the line-of-sight direction, and the like will be described.

### <Audio Adjustment Processing>

FIG. 16 is a diagram illustrating an example of audio adjustment according to a situation.

FIG. 16 illustrates a situation (scene) in which three or more Ghosts (Ghost1, Ghost2, Ghost3, and the like) participate in with respect to one Body in addition to the user P, and the large number of people performs JackIn and are talking. At this time, the audio processing to be applied to the audio (audio signal) is dynamically changed among the audios of the Body and the three or more Ghosts so that the user P can easily hear the audio of the Body. Although details will be described below, as the audio processing, for example, processing of a sound pressure, an equalizer (EQ), a reverb, or adjustment of a localization position is performed.

As described above, by making the audio of the Body easier to hear than the audios of the three or more Ghosts, the user P can easily hear the audio of the Body that is important to the user P. For example, when the Ghost including the user P silently listens to a guidance while the Body guides the sightseeing spot with JackIn, the user P can easily hear the audio of the guidance of the Body.

Alternatively, in a situation where there is a plurality of audios and there is an audio that each participating user wants to listen to, such as a user who is speaking an impression, a question, or the like to the guidance of the Body, or users who are having a conversation between the Ghosts, the audio processing may be dynamically changed so that the audio of the Ghost can be easily heard. For example, in FIG. 16, while the audio of the Ghost1 who is speaking the impression or the like can be made to be easily heard, the audio of the Ghost2 or the Ghost3 can be made to be somewhat audible or difficult to hear.

As a result, the user P can easily hear the audio important to the user P. The user P only needs to perform a natural action such as changing the direction or paying attention in order to listen to an important audio. Alternatively, the user P can hear while maintaining clarity such as being able to hear even if there is an unimportant audio, being aware of a word of interest, or being able to respond to a call.

Here, important factors known in advance according to a situation, such as that the audio of the Body is important to the whole, that the audio of the user in the same group is important, or that the audio of a staff is important, can be incorporated into listening easiness of the audio and designed in advance.

### <Configuration of Audio Processing Unit>

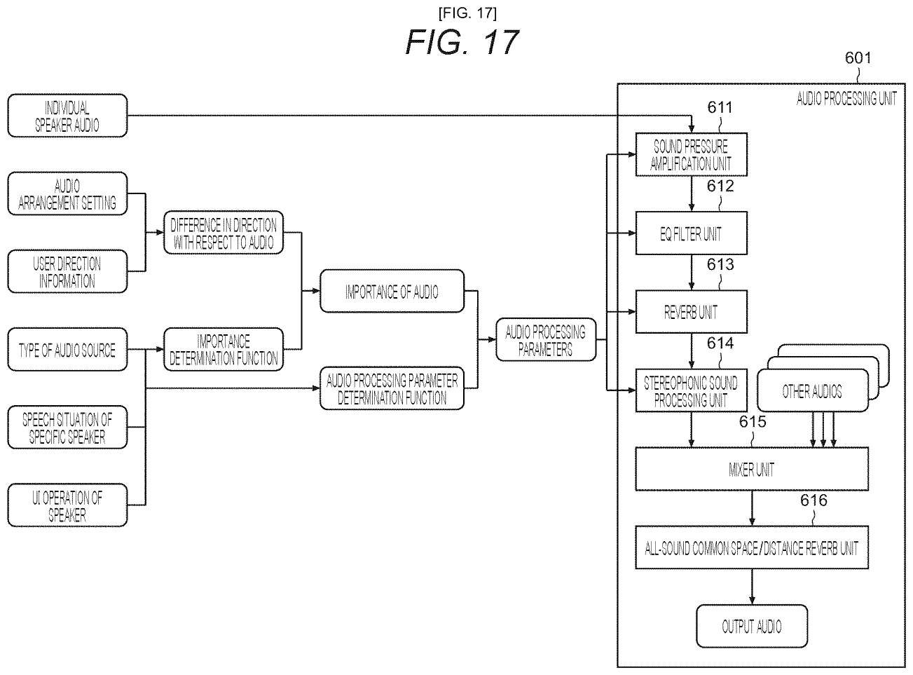

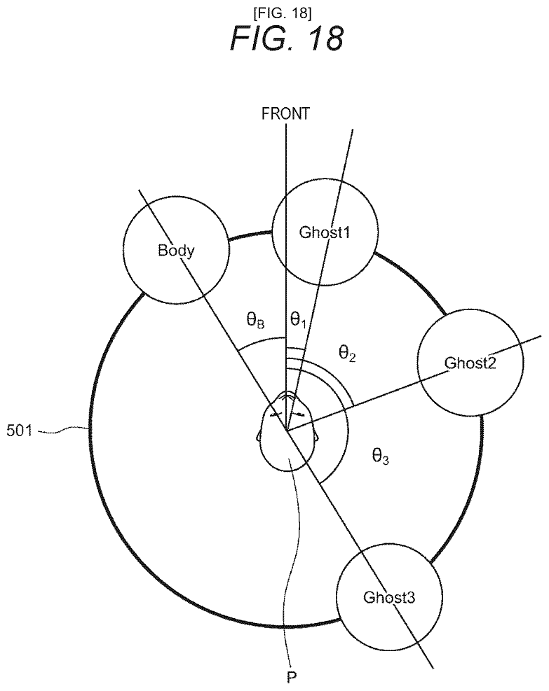

FIG. 17 is a diagram illustrating a configuration example of an audio processing unit 601. The audio processing unit 601 in FIG. 17 can be included in, for example, a processing unit 102 of a distribution device 10 or a processing unit 202 of a viewing device 20 in FIG. 5. Note that description of FIG. 17 will be given with reference to FIGS. 18 to 22 as appropriate.

In FIG. 17, the audio processing unit 601 includes a sound pressure amplification unit 611, an EQ filter unit 612, a reverb unit 613, a stereophonic sound processing unit 614, a mixer unit 615, and an all-sound common space/distance reverb unit 616.

In the audio processing unit 601, an audio signal corresponding to an individual speech audio is input to the sound pressure amplification unit 611, and audio processing parameters are input to the sound pressure amplification unit 611, the EQ filter unit 612, the reverb unit 613, and the stereophonic sound processing unit 614.

The individual speech audio is an audio signal corresponding to an audio spoken by the user such as the Body or the Ghost. The audio processing parameter is a parameter used for audio processing of each unit, and is obtained as follows, for example.

That is, an importance of the audio can be determined using an importance determination function I(θ) designed in advance. The importance determination function I(θ) is a function that determines the importance according to an angular difference of the audio with respect to the front of the user P. The angular difference of the audio with respect to the front of the user P is calculated as a difference in direction with respect to the audio, for example, from arrangement of the audio and user orientation information. As illustrated in FIG. 18, in a case where one Body and three Ghosts (Ghost1, Ghost2, and Ghost3) participate, as the angular difference of the audio with respect to the front of the user P, the angular difference from the Body is θ_{B}, the angular difference from the Ghost1 is θ₁, the angular difference from the Ghost2 is θ₂, and the angular difference from the Ghost3 is θ₃.

The shape of the importance determination function I(θ) changes according to a type of an audio source, a speech situation (presence or absence of speech) of a specific speaker, and a user interface (UI) operation of the speaker. Usually, the importance determination function I(θ) is designed such that the importance decreases from the front to the back of the user P.

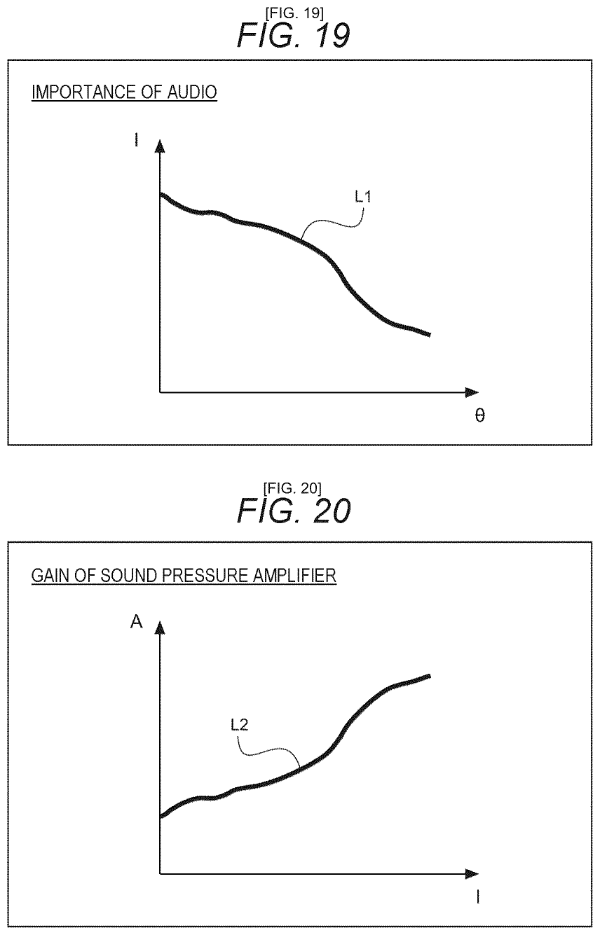

FIG. 19 is a graph illustrating an example of the importance I of the audio determined by the importance determination function I(θ). In FIG. 19, a relationship (I=I(θ)) between the importance I and the angular difference θ when the vertical axis represents the importance I of the audio and the horizontal axis represents the angular difference θ is represented by a curve L1. As indicated by the curve L1, the importance I decreases as the angular difference θ increases.

When calculating the importance of the audio, which one of the Body and the Ghost the audio is, whether the user is viewing (facing) a direction of the audio (sound image) being spatially localized, and the like are considered. Note that the above-described importance determination function I(θ) is an example. For example, in a case where attention is guided to a direction in which the user P is not viewing, it is sufficient to design the importance determination function I(θ) in which the importance of the front surface is low and the importance becomes higher toward the back surface, contrary to the above-described example.

By applying an audio processing parameter determination function to the importance of the audio determined in this manner, the audio processing parameter is determined and input to each unit.

The sound pressure amplification unit 611 adjusts the audio signal input thereto to a sound pressure corresponding to a gain value input as the audio processing parameter, and outputs a resultant audio signal to the EQ filter unit 612. This gain value is uniquely determined by a sound pressure amplifier gain determination function A(I) as the audio processing parameter determination function according to the importance I of the audio designed in advance.

The shape of the sound pressure amplifier gain determination function A(I) changes according to the type of an audio source, the speech situation of a specific speaker, and the UI operation of the speaker. Normally, the sound pressure amplifier gain determination function A(I) is designed such that the gain value decreases in conjunction with a decrease in the importance of the audio.

FIG. 20 is a graph illustrating an example of a gain value determined by the sound pressure amplifier gain determination function A(I). In FIG. 20, a relationship (A=A(I)) between a gain A and the importance I when the vertical axis represents the gain A [dB] of the sound pressure amplifier and the horizontal axis represents the importance I of the audio is represented by a curve L2. As indicated by the curve L2, the gain A of the sound pressure amplifier decreases as the importance I decreases.

The EQ filter unit 612 applies an EQ filter corresponding to the gain value input as the audio processing parameter to the audio signal input from the sound pressure amplification unit 611, and outputs a resultant audio signal to the reverb unit 613. The EQ filter is designed to satisfy a relationship of E [dB]=E(f)*E_{A}(I). E(f) is an EQ value uniquely determined according to the importance I of the audio designed in advance. The filter is set such that an increased/decreased value varies for each frequency f.

E_{A}(I) is a gain value determined by an EQ filter gain determination function E_{A}(I) as the audio processing parameter determination function, and determines the degree of application of the EQ filter from the importance I of the audio designed in advance. As the value of E_{A}(I) increases, the degree of application of the EQ filter increases. The shape of the EQ filter gain determination function E_{A}(I) changes according to the type of an audio source, the speech situation of a specific speaker, and the UI operation of the speaker. Normally, the filter is designed to be strengthened from the front to the back of the user P.

FIG. 21 is a graph illustrating an example of the gain value determined by the EQ filter gain determination function E_{A}(I). In FIG. 21, a relationship (E_{A}=E_{A}(I)) between a gain E_{A} and the importance I when the vertical axis represents the gain E_{A} (E_{A}(I)) of the EQ filter and the horizontal axis represents the importance I of the audio is represented by a curve L3. As indicated by the curve L3, the gain E_{A} of the EQ filter increases as the importance I decreases, and the EQ filter is strengthened from the front to the back of the user P. Note that, in many cases, processing of changing a tone of the audio without impairing language information of the audio by a high-cut filter, that is, a low-pass filter (LPF), as the EQ filter, is suitable.

The reverb unit 613 applies a reverb corresponding to a ratio value of the reverb input as the audio processing parameter to the audio signal input from the EQ filter unit 612, and outputs a resultant audio signal to the stereophonic sound processing unit 614. The ratio value of the reverb is a value for determining a ratio of how much the reverb is applied to the input audio signal using the reverb (for example, reverberation expression) created in advance. The ratio value of the reverb is uniquely determined by the reverb ratio determination function R(I) as the audio processing parameter determination function according to the importance I of the audio designed in advance.

The shape of the reverb ratio determination function R(I) changes according to the type of an audio source, the speech situation of a specific speaker, and the UI operation of the speaker. For example, the audio becomes clearer in a state where the reverb is not applied (R=0), while the audio is output more unclear in a state where the reverb is stronger (R=100).

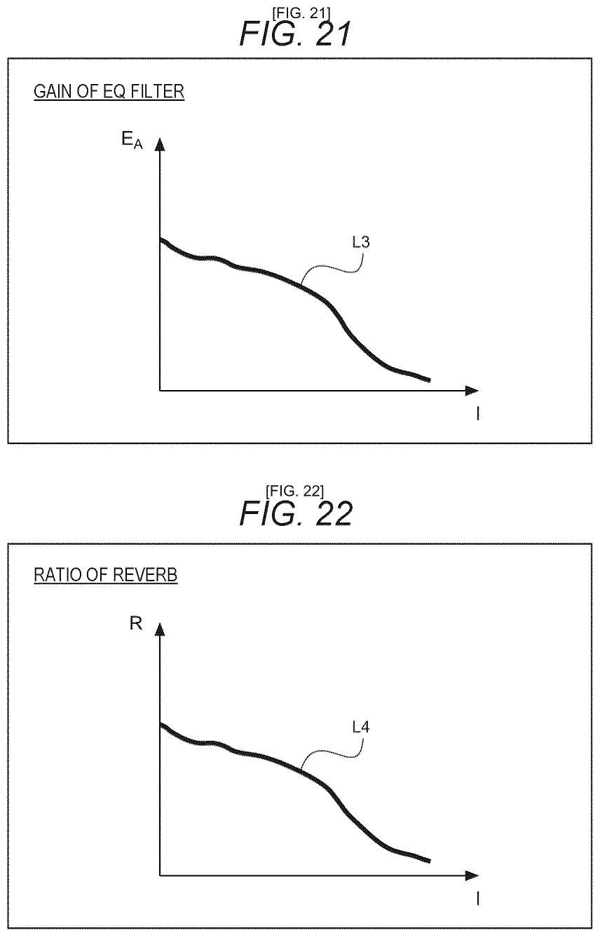

FIG. 22 is a graph illustrating an example of the ratio value of the reverb determined by the reverb ratio determination function R(I). In FIG. 22, a relationship (R=R(I)) between a ratio R of the reverb and the importance I when the vertical axis represents the ratio R of the reverb and the horizontal axis represents the importance I of the audio is represented by a curve L4. As indicated by the curve L4, the ratio R of the reverb increases as the importance I decreases, and for example, the audio can be output unclearly from the front to the back of the user P.

The stereophonic sound processing unit 614 applies the stereophonic sound processing according to the audio processing parameters to the audio signal input from the reverb unit 613, and outputs a resultant audio signal to the mixer unit 615.

For example, as the stereophonic sound processing, two pieces of processing including first processing that is processing of raising an arrangement of a sound to an upper side of arrangement of other sounds and second processing that is processing of expanding spread (apparent width) of a sound to be larger than the other sounds are added in addition to the control of localizing the audio (sound image) according to the view direction of the user described above to cause the audio with high importance to stand out more.

In particular, regarding the first processing, while an attention point of a user concentrates on a horizontal plane and the audio also concentrates on the horizontal plane in whole, a pitch of the important audio increases, so that an effect of making the audio more easily recognized can be obtained. Regarding the second processing, while the normal audio is presented as a point sound source, the important audio is presented with a spread (apparent width), so that the presence is more emphasized and presented, and an effect of making recognition easier can be obtained.

Note that, in the second processing, when the processing of widening the sound spread (apparent width) is performed, only a longitudinal direction may be widened, only a lateral direction may be widened, or both the longitudinal and lateral directions may be widened. Furthermore, the stereophonic sound processing may be performed in addition to the control of localizing the audio (sound image) at the attention point of the user described in FIG. 14 and the like.

The mixer unit 615 mixes the audio signal input from the stereophonic sound processing unit 614 with another audio signal input thereto, and outputs a resultant audio signal to the all-sound common space/distance reverb unit 616. Although not described in detail, the sound pressure amplification unit 611 to the stereophonic sound processing unit 614 can also apply processing using the audio processing parameters to other audio signals, similarly to the audio signal input from the stereophonic sound processing unit 614.

The all-sound common space/distance reverb unit 616 applies a reverb for adjusting a space and a distance common to all sounds to the audio signal input from the mixer unit 615 so that the audio of the user (Body or Ghost) is output as a stereophonic sound from an audio output unit such as a headphone or a speaker. Therefore, all the audios after the stereophonic sound processing are added and output.

As described above, in the audio processing unit 601, the audio processing is applied to the individual audio according to the importance of the audio and an attribute of the audio. In this audio processing, processing of dynamically adjusting at least one of the sound pressure, EQ, reverb, or spatial localization can be performed between the audios of the users. Note that it is not necessary to perform all pieces of the audio processing, and another audio processing may be added.

For example, by this audio processing, a localization position of the audio of the Body can be arranged above the audios of other Ghosts. Furthermore, audio processing such as lowering the sound pressure of the audio with low importance, lowering the sound pressure in a high frequency/low frequency band by the EQ, or strengthening how the reverb is applied can be performed to make the audio less noticeable. Such audio processing enables smooth communication between users.

In a case where the audio processing unit 601 in FIG. 17 is configured as a part of a processing unit 102 of a distribution device 10 or a processing unit 202 of a viewing device 20 in FIG. 5, in a case where the audio output unit 114 or the audio output unit 214 is configured as headphones, stereophonic sound conversion is performed according to acoustic characteristics for each headphones such as headphone inverse characteristics and transfer characteristics to the user's ears. Furthermore, in a case where the audio output unit 114 or the audio output unit 214 is configured as speakers, stereophonic sound production is performed in accordance with the number and arrangement of the speakers.

Note that, in FIG. 17, the user direction information may be information regarding a line-of-sight or an attention point of the user. For example, in a case of the user who is likely to get motion sickness or the user who has an experience in a seated state, it may be difficult to change the direction. In that case, a method of calculating the importance of the audio from viewpoint information indicating where in an omnidirectional image the user is gazing at, instead of the head direction of the user, is suitable. In a case where the Ghost browses an image of JackIn in a browser, it is suitable to treat a center point of the browsed image as a viewpoint or treat an attention point in a viewpoint camera as a viewpoint to calculate the attention point of the user and the importance of the audio.

Furthermore, in FIG. 17, examples of use of the change in the functions (including the importance determination function and the audio processing parameter determination function) according to the types of the audio source include the following. That is, it is possible to make a difference in how a sound is heard even by the same Ghost by subdividing the Ghost and dividing the Ghosts into the same group and a different group, or dividing the Ghosts into an operating group and a participant group.

For example, in a case where both a customer and a staff of a travel company participate as Ghosts in a virtual travel tour, the audio of the staff needs to stand out even of the staff is the Ghost. Furthermore, even in the case of the same customer, the importance of the audio for the user is different between a group of user's own family and friends and a group of strangers. In such a case, it is desirable to divide the entire Ghosts into a plurality of groups, set the importance of the audio for each group, and change the audio processing, instead of treating the entire Ghosts in the same way.

In a case where it is desired to attract attention to information outside a field of view of the user who is a participant, it is only required to design a shape of a function in which the importance of the audio is higher outside the field of view and the audio is presented to stand out by changing the type of the audio source.

Furthermore, in FIG. 17, examples of use of the change in the functions (including the importance determination function and the audio processing parameter determination function) according to the speech situation (presence or absence of speech) of the specific speaker include the following. That is, when a user (speaker) having a special role in a JackIn experience, such as a Body or a guide in a virtual tour, speaks, the audio of the special role needs to stand out. At this time, when a user having a special role speaks, the parameters such as the importance, sound pressure, and EQ of the audios of other users may be lowered in whole.

Furthermore, in FIG. 17, examples of use of the change in the functions (including the importance determination function and the audio processing parameter determination function) by the UI operation of the speaker include the following. That is, there is a situation where it is desired to temporarily suppress a conversation of other users (participants) when the user (speaker) makes an announcement or calls attention to the whole. At that time, the user (speaker) may explicitly perform a UI input such as pressing a button, facing a specific direction (such as gazing at the UI in the field of view), or performing a specific gesture, so that the importance of the speaker's audio is increased, and whereas the parameters such as the importance, sound pressure, and EQ of the audios of the other users (participants) may be dropped in whole.

### <Adjustment of Line-of-Sight Guidance>

In a case where a certain target is designated in communication between the Body and the Ghost or between the Ghosts, it is assumed that the target is designated by using demonstratives such as “this” and “that”, but what is designated is often unknown. Therefore, where another user wants to designate is made recognizable from the direction of a line-of-sight guidance sound by the spatial localization of the audio. Here, by using stereophonic sound of 360 degrees, the line-of-sight can be guided to the outside the line-of-sight of the user by the line-of-sight guidance sound.

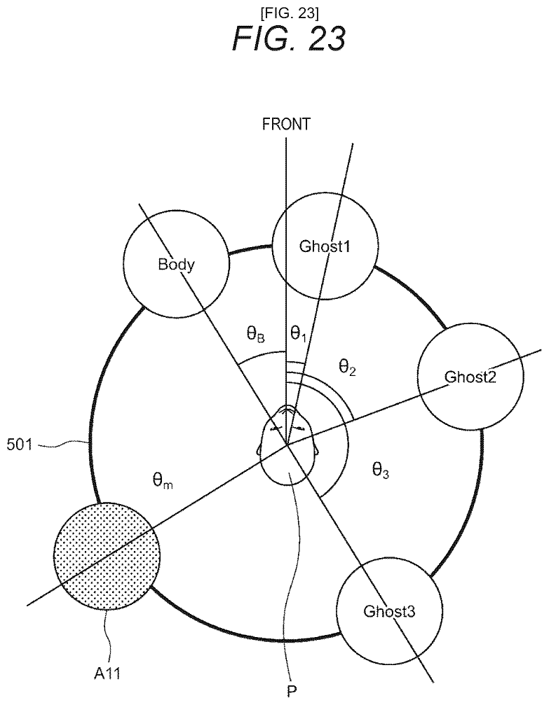

FIG. 23 is a diagram illustrating an example of a method of presenting the line-of-sight guidance sound. As illustrated in FIG. 23, in a case where one Body and three Ghosts participate as other users in addition to the user P, the spatial localization of the audio is performed such that a line-of-sight guidance sound A11 is emitted from the direction of the target that another user wants to designate. As a method of designating a line-of-sight guidance destination, conditions such as the line-of-sight and a face direction of another user are designated in advance by a graphical user interface (GUI). As the line-of-sight guidance sound A11, a sound for guiding a line-of-sight such as a sound effect or an audio can be used. Therefore, the user P can recognize in which direction another user who has spoken “This temple” shows an interest from the direction of the line-of-sight guidance sound A11, for example.

As for the line-of-sight guidance sound, it is possible to perform processing of making the sound stand out in a case where the angle outside the field of view is apart and presenting the sound with a normal sound when the sound enters the field of view, on the contrary to the above-described processing of making the sound stand out as the angular difference θ from a sound source is smaller.

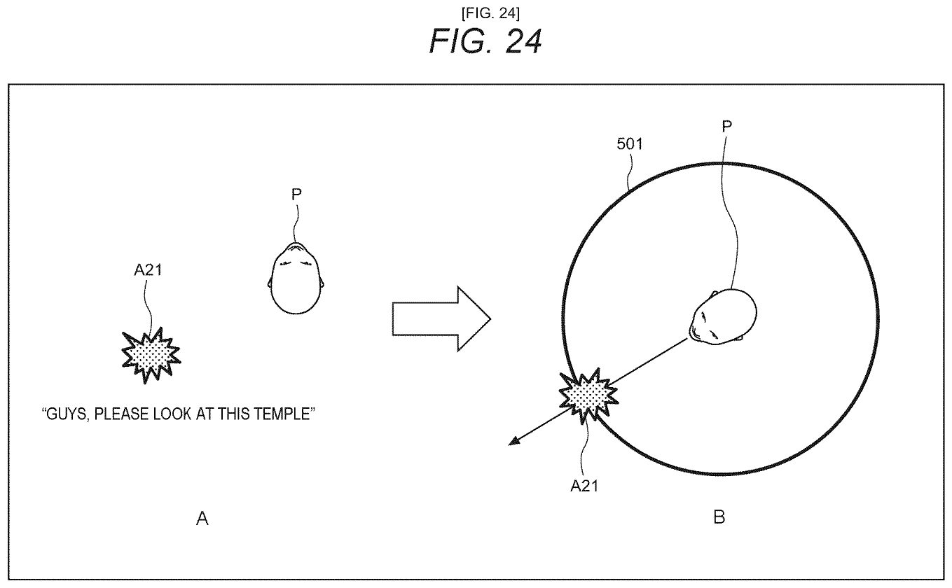

For example, as illustrated in FIG. 24, when another user has spoken “Guys, please look at this temple.”, the processing of making a line-of-sight guidance sound A21 emitted from outside the field of view of the user P stand out is performed for the user P. When the user P reacts to the line-of-sight guidance sound A21 and faces the direction, and “this temple” enters the field of view, processing of presenting the line-of-sight guidance sound A21 with a normal sound is performed. As a result, it is possible to reliably guide the user to the guidance point outside the field of view by making the line-of-sight guidance sound stand out.

Note that, in a case where the user P is a Body, the guidance destination of the line-of-sight may be designated on a real space using a pointing device. Furthermore, in combination with image recognition, a target may be recognized and designated from a pointing destination.

In a case of an angular difference in which identification of the spatial localization of the audio is difficult, a sense of localization may be emphasized by intentionally increasing the angle to facilitate the guidance of the line-of-sight. Furthermore, in a case where a localization position overlaps with another localization position, identification is difficult. Therefore, the line-of-sight guidance sound may be made stand out by intentionally disposing the localization position at a position not overlapping with the another localization position. In a case where an audio (speech) is output as the line-of-sight guidance sound, a notification sound may be virtually output to call the user P's attention before a guidance speech. In this case, the speech is buffered and presented in a delayed manner. Alternatively, a target for presenting the line-of-sight guidance sound may be designated. For example, as the target for presenting the line-of-sight guidance sound, it is possible to designate that the line-of-sight guidance sound is only heard by the same group, heard by the whole, or presented only to users nearby.

### <Sharing of Stationary Indication>

By the way, for each user, localization of a sound cannot be known unless another user speaks, and thus, there is a case where a direction or a place in which the another user is interested is not known. Therefore, by presenting a virtual stationary sound (indication sound) for each user, each user can always recognize the direction or the place in which another user is interested from the localization of the stationary sound even in a case where the another user does not speak. This makes it possible to transmit an indication by sound (non-verbal communication).

As the stationary sound, for example, noise such as white noise can be used. The stationary sound may be prepared for each user. For example, different footsteps, heartbeat, breathing, or the like for each user may be presented as the stationary sound from an attention direction.

As a method of controlling the stationary sound, for example, the following control can be performed. That is, control for setting a state of presenting the stationary sound as an on state, and a state of not presenting the stationary sound as an off state, and turning the state to the on state when detecting a silent section and turning the state to the off state when detecting the speech of the user can be performed.

Control for switching the on state and the off state may be performed according to an explicit operation by the user. For example, an indication button (not illustrated) is provided in the distribution device 10 or the viewing device 20, and when the indication button is operated by the user, the stationary sound can be switched to the on state or the off state.

A state of the user may be detected, and control for switching the stationary sound to the on state or the off state may be performed according to the user state. For example, the stationary sound can be switched to off state when it is detected that the user has left a seat, or can be switched to the on state when it is detected that the user is looking at a screen.

When the user is gazing at a certain area, control for not only switching the stationary sound to the on state but also making the stationary sound larger (making the sound gradually larger) according to a gazing time may be performed. Furthermore, control for making the stationary sound larger in a case where an area at which the user is gazing moves, while making the stationary sound smaller in a case where the area continues to stay may be performed. As a result, it is possible to prevent the stationary sound from becoming uncomfortable for the user.

Control for presenting the stationary sound only to a specific group may be performed. By performing such control, it is possible to suppress an increase in overlap of the stationary sounds in a case where there is a large number of users, for example. Alternatively, in a case where the number of users is large, it becomes difficult to identify the localization sound for each individual user, and thus, for example, control for dividing the direction into N, and generating and presenting the stationary sound by the group according to a participation ratio of the users in each of the N divided directions may be performed.

In this manner, by controlling the stationary sound (indication sound) and sharing a stationary indication by sharing the virtual stationary sound, it is possible to sense the indication of another user even in a state where the another user does not speak. As a result, the direction in which a certain user is interested can be recognized in advance, and communication between the users becomes smooth. For example, a scene is assumed in which, when the Ghost1 senses an indication of the Ghost2 by the stationary sound, the Ghost1 can face the direction of the indication because the Ghost2 is looking at the Ghost1 side, and then the speech of the Ghost2 is started.

Note that the second embodiment may be combined with the first embodiment or may be implemented alone. That is, the audio processing unit 601 illustrated in FIG. 17 is not limited to the configuration of being included in the processing unit 102 of the distribution device 10 or the processing unit 202 of the viewing device 20 in FIG. 5, and may be incorporated in another audio device, or the audio processing unit 601 may be configured as a single device as an audio processing device.

### Third Embodiment

### <Control According to Priority>

Spatial localization (stereophonic sound localization) of an audio can be controlled according to the number of participating users. For example, in a case where the number of Ghosts is increased to a large number such as 100, superiority and inferiority of the users can be controlled by stereophonic sound localization and audio processing.

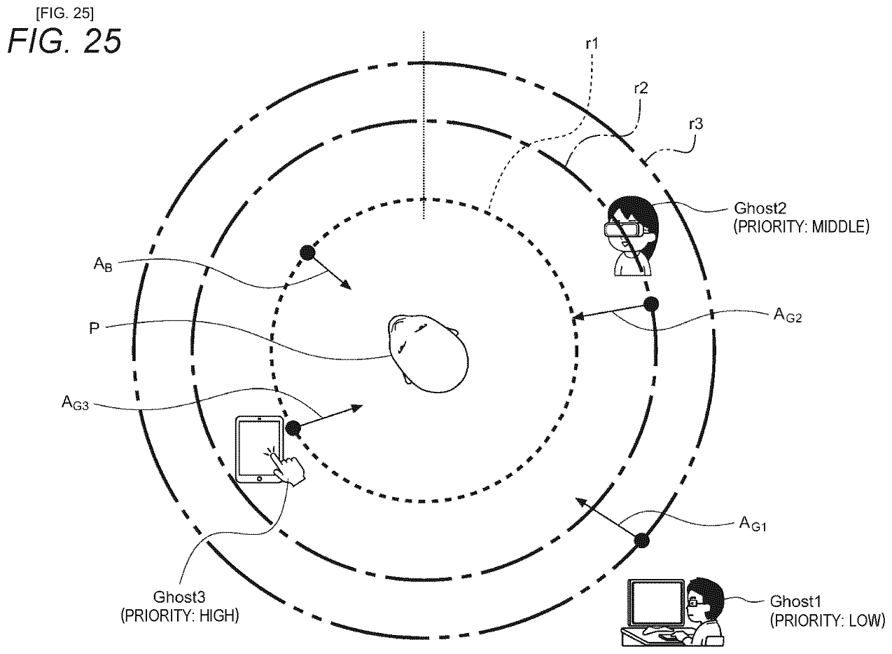

FIG. 25 is a diagram illustrating an example of control in a depth direction of audio localization according to priority. In FIG. 25, Ghost1 using a PC, Ghost2 using an HMD, and Ghost3 using a smartphone participate in addition to a user P as a Body. In FIG. 25, similarly to FIG. 13, three circles having different line types represent a depth distance r in an omnidirectional image 501, and have a relationship of r1<r2<r3.

Here, in a case where three levels of priority of high, middle, and low can be set as the priority for the user P, when the priority of the Ghost1 is low, the priority of the Ghost2 is middle, and the priority of the Ghost3 is high, the depth direction of audio localization of each Ghost is controlled according to the priority. At this time, the audio of the Ghost3 with high priority is set to be heard from a closer place (from the direction of the arrow A_{G3}), while the audio of the Ghost1 with low priority is set to be heard from a farther place (from the direction of the arrow A_{G1}). Furthermore, the audio of the Ghost2 with middle priority is set to be heard from the middle between the audio of the Ghost3 and the audio of the Ghost1 (from the direction of the arrow A_{G2}). Note that there may be a user who only views. Note that not only the audio of the Ghost but also the audio of the Body can be similarly controlled.

When localizing (stereophonic sound localization) the audio of each Ghost in the depth direction according to the priority, control to perform audio processing such as sound pressure, EQ, or reverb may be performed on the basis of an importance determination function described in FIG. 17 and the like, or control to raise or widen a localization position of the audio may be performed.

As a method of setting the priority, the following methods can be used, for example. That is, it is possible to set the priority of the Ghost by the Body selecting the Ghost or the Body giving approval in response to a request from the Ghost. Furthermore, it is possible to set the priority to be higher for a Ghost with a larger charging amount or a Ghost with a higher degree of contribution (for example, a larger amount of remarks) by using the charging amount regarding a system of Ghosts or the degree of contribution in a community or a group of Ghosts, as an index.

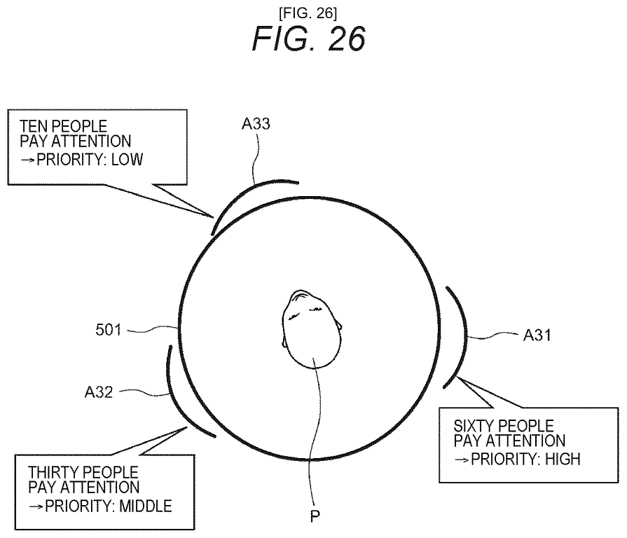

The priority may be set according to an attention amount (attention degree) of an image in the omnidirectional image. As illustrated in FIG. 26, in the omnidirectional image 501, it is assumed that sixty Ghosts focus on an area A31, thirty Ghosts focus on an area A32, and ten Ghosts focus on an area A33. At this time, it is possible to set the priority of the area A31, which is a place where the number of people who pay the attention is the largest, to high, set the priority of the area 32, which is a place where the number of people who pay the attention is the second largest, to middle, and set the priority of the area 32, which is a place where the number of people who pay the attention is the smallest, to low.

### <How to Hear Ghost Audio>

For the Ghost, how to hear the audio of the Body and the audio of another Ghost is as follows, for example.

First, regarding how the Ghost hears the audio of the Body, control is performed such that the audio is switched depending on whether the Body wants to talk with a specific Ghost or contents desired to be shared by all the participating Ghosts (all the participating Ghosts).

In a case where the Body speaks to a specific Ghost, for example, the control is performed such that the importance of the audio of the Body is changed according to the height of the priority of the Ghost, and the audio of the Body can be heard well by the Ghost with high priority and the audio of the Body cannot be heard well by the Ghost with low priority. Here, the specific Ghost is a very important person (VIP) participant, and a scene where a conversation between a specific Ghost that is the VIP participant and a Body is transmitted to another Ghost that is a general participant is assumed.

In a case where the Body is shared by all the participating Ghosts, control is performed such that the audio of the Body is switched to mono or the importance of each audio is switched to increase as an announce mode, and the audio of the Body is commonly heard by all the participating Ghosts. For example, in a case where the Body is a guide of a tourist tour and all the participating Ghosts are participants of the tourist tour, a scene where the Body notifies all the participating Ghosts of a place that the Body wants to attract attention is assumed.

Next, regarding how the Ghost hears the audio of another Ghost, the Ghost can also set the priority to another Ghost, similar to the Body. As a method of setting the priority, for example, there are the following methods. That is, it is possible to select a Ghost whose audio is desired to listen, such as an acquaintance or a celebrity. Furthermore, it is possible to set the priority, using the charging amount of the Ghost, the degree of contribution (for example, the amount of remarks) in the community of Ghosts, or the like, as an index. Alternatively, as illustrated in FIG. 26, the priority of a place where a large number of people pays attention may be increased according to an attention amount of an image in the omnidirectional image. Furthermore, the priority of the audio of another Ghost having a close attention point to the Ghost itself in the omnidirectional image may be increased.

### <Division of Ghost Group>

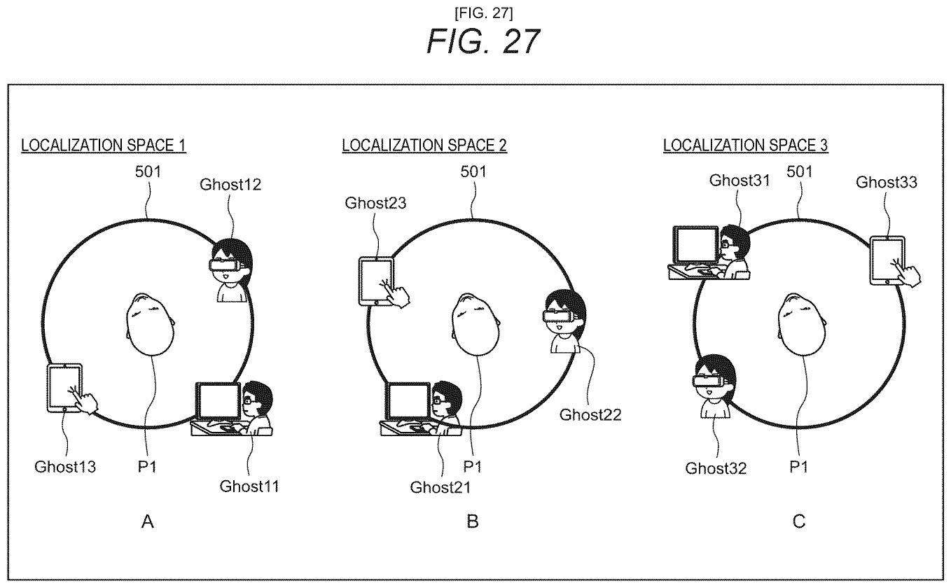

For example, the localization space of the audio may be divided for each specific group among all the participants, such as a group of good friends. FIG. 27 is a diagram illustrating an example in which a localization space of an audio is divided for each specific group.

A of FIG. 27 illustrates a localization space of an audio for a group including Ghost11, Ghost12, and Ghost13 as a localization space 1, and a conversation between the distributor P1 (Body) and the Ghost11, the Ghost12, and the Ghost13 is possible. B of FIG. 27 illustrates a localization space 2 of an audio for a group including Ghost21, Ghost22, and Ghost23, and a conversation between the distributor P1 (Body) and the Ghost21, the Ghost22, and the Ghost23 is possible. C of FIG. 27 illustrates a localization space 3 of an audio for a group including Ghost31, Ghost32, and Ghost33, and a conversation between the distributor P1 (Body) and the Ghost31, the Ghost32, and the Ghost33 is possible.

In the three localization spaces 1 to 3 illustrated in A to C of FIG. 27, distribution of the omnidirectional image 501 from the distributor P1 (Body) is viewed at the same time, but the conversation is divided in each localization space. That is, each Ghost can listen to the conversation in the localization space in which the each Ghost is located, but cannot listen to the conversation in the other localization spaces. Note that, for each Ghost, the audio in another localization space other than its own localization space may enter the own localization space as a small and distant audio.

Since the audios of the three localization spaces 1 to 3 are mixed, the distributor P1 (Body) can communicate with each group. By setting the priority of the localization space, it is possible to switch from which localization space the audio is heard well according to the priority.

As a method of switching the localization space, for example, there is the following method. That is, it is possible to switch the localization space by the Body selecting the localization space, the Body giving approval to a request for each localization space, giving priority to the localization space having a larger total amount of conversation, or the like.

### <Modifications>

The surrounding captured image captured by the imaging unit 112 as an imaging device is not limited to the omnidirectional image, and may be, for example, a half celestial sphere image or the like not including a floor surface with little information, and the above-described “omnidirectional image” can be read as a “half celestial sphere image”. Furthermore, since a video includes a plurality of image frames, the above-described “image” may be read as a “video”.

The omnidirectional image does not necessarily have to cover 360 degrees, and a part of the field of view may be missing. Furthermore, the surrounding captured image is not limited to the captured image captured by the imaging unit 112 such as an omnidirectional camera, and for example, may be generated by performing image processing (synthesis processing or the like) for the captured images captured by a plurality of cameras. Note that the imaging unit 112 including a camera such as an omnidirectional camera is provided for the distributor P1, but may be attached to the head of the distributor P1 (Body) so as to capture the line-of-sight direction of the distributor P1 (Body), for example.

### <Configuration Example of Computer>

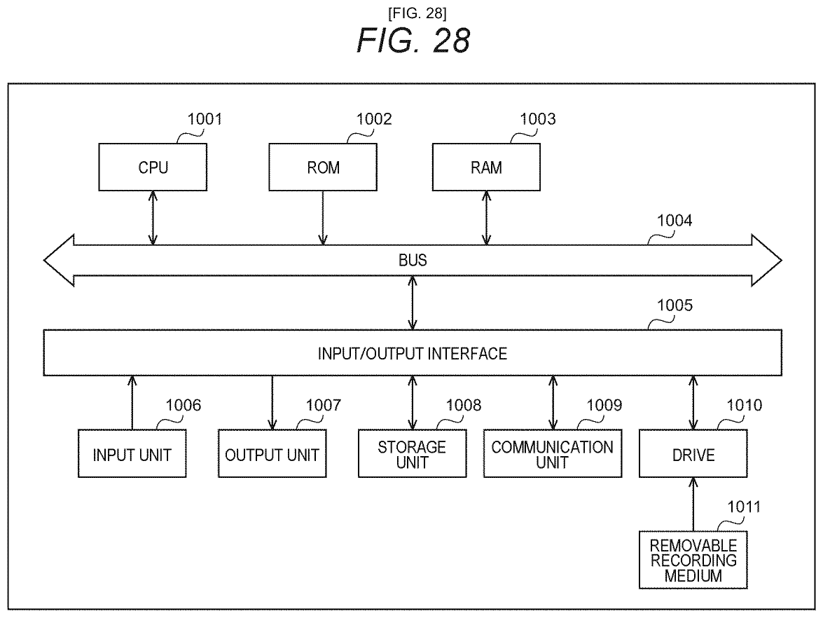

The series of processing described above can be executed by hardware or software. In a case where the series of processes is executed by software, a program constituting the software is installed on a computer. FIG. 28 is a block diagram illustrating a configuration example of the hardware of the computer that executes the above-described series of processing by the program.

In the computer, a CPU 1001, a read-only memory (ROM) 1002, and a random-access memory (RAM) 1003 are mutually connected by a bus 1004. Moreover, an input/output interface 1005 is connected to the bus 1004. An input unit 1006, an output unit 1007, a storage unit 1008, a communication unit 1009, and a drive 1010 are connected to the input/output interface 1005.

The input unit 1006 includes a keyboard, a mouse, a microphone and the like. The output unit 1007 includes a display, a speaker, and the like. The storage unit 1008 includes a hard disk, a non-volatile memory, and the like. The communication unit 1009 includes a network interface and the like. The drive 1010 drives a removable recording medium 1011 such as a semiconductor memory, a magnetic disk, an optical disk, or a magneto-optical disk.

In the computer configured as described above, the CPU 1001 loads a program recorded in the ROM 1002 or the storage unit 1008 into the RAM 1003 via the input/output interface 1005 and the bus 1004 and executes the program, so as to perform the above-described series of processes.

A program executed by the computer (CPU 1001) can be provided by being recorded on the removable recording medium 1011 as a package medium, or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by mounting the removable recording medium 1011 to the drive 1010. Furthermore, the program can be received by the communication unit 1009 via a wired or wireless transmission medium and installed in the storage unit 1008. Alternatively, the program can be installed into the ROM 1002 or the storage unit 1008 in advance.

Here, in the present description, the process to be performed by the computer in accordance with the program is not necessarily performed in time series according to orders described in the flowcharts. That is, the processing executed by the computer in accordance with the program also includes processing that is executed in parallel or individually (for example, parallel processing or object processing). Furthermore, the program may be executed by one computer (processor), or may be executed by a plurality of computers in a distributed manner.

Note that embodiments of the present disclosure are not limited to the embodiment described above, and various modifications may be made without departing from the scope of the present disclosure. Furthermore, the effects described herein are merely examples and are not limited, and there may be other effects.

Furthermore, the present disclosure can have the following configurations.
(1)

An information processing device including:
a control unit configured to
perform control of spatial localization of an audio of another user except a target user on a basis of information regarding at least one of a view direction of a first user corresponding to a captured image captured by an imaging device provided for the first user or a view direction of a second user who views a surrounding captured image in which surroundings of a position where the first user exists are captured as the captured image.
(2)

The information processing device according to (1) above, in which,
in a case where the target user is the first user and the another user is the second user, when a change in the view direction of the first user is detected, the control unit rotationally corrects the surrounding captured image and the audio of the second user in a direction of offset in accordance with a rotation amount according to the detected change in the view direction of the first user.
(3)

The information processing device according to (2) above, in which,
when a change in the view direction of the second user is detected, the control unit rotationally corrects the audio of the second user in accordance with a rotation amount according to the detected change in the view direction of the second user.
(4)

The information processing device according to (1) above, in which,
in a case where the target user is the second user and the another user is the first user, when a change in the view direction of the first user is detected, the control unit rotationally corrects the audio of the first user in accordance with a rotation amount according to the detected change in the view direction of the first user.
(5)

The information processing device according to (4) above, in which,
when a change in the view direction of the second user is detected, the control unit rotationally corrects the audio of the first user in a direction of offset in accordance with a rotation amount according to the detected change in the view direction of the second user.
(6)

The information processing device according to (1) above, in which,
in a case where the target user is the second user and the another user is another second user different from the second user, when a change in the view direction of the second user is detected, the control unit rotationally corrects the audio of the another second user in a direction of offset in accordance with a rotation amount according to the detected change in the view direction of the second user.
(7)

The information processing device according to (6) above, in which,
when a change in the view direction of the another second user is detected, the control unit rotationally corrects the audio of the another second user in accordance with a rotation amount according to the detected change in the view direction of the another second user.
(8)

The information processing device according to any one of (1) to (7) above, in which
the control unit controls the spatial localization of the audio of the another user in a depth direction on a basis of a distance in the depth direction of an object in a field of view of each of the first user and the second user.
(9)

The information processing device according to any one of (1) to (7) above, in which
the control unit specifies an attention point of the another user and fixes a localization direction of the audio of the another user to the specified attention point.
(10)

The information processing device according to any one of (1) to (7) above, further including:
an audio processing unit configured to perform processing of adjusting the audio of the another user.
(11)

The information processing device according to (10) above, in which
the audio processing unit adjusts the audio of the another user on a basis of importance of the audio of the another user and an attribute of the audio.
(12)

The information processing device according to (11) above, in which
the audio processing unit performs processing of dynamically adjusting at least one of a sound pressure, an equalizer (EQ), a reverb, or the spatial localization between the audios of the other users.
(13)

The information processing device according to (12) above, in which
the audio processing unit adjusts the audio of each of the other users on a basis of a relationship between the other users.
(14)

The information processing device according to (10) above, in which
the audio processing unit adjusts the spatial localization of a line-of-sight guidance sound for guiding a line-of-sight of the target user.
(15)

The information processing device according to (10) above, in which
the audio processing unit adjusts spatial localization of a virtual stationary sound corresponding to the another user with respect to the target user.
(16)

The information processing device according to any one of (1) to (7) above, in which
the control unit controls the spatial localization of the audio of the another user in a depth direction on a basis of priorities of the first user and the second user.
(17)

The information processing device according to any one of (1) to (7) above, in which,
in a case where the target user is the first user and the another user is the second user, when there is a plurality of the second users, the control unit divides the second users into specific groups and divides the spatial localization of the audio for each of the specific groups.
(18)

The information processing device according to any one of (1) to (7) above, in which
the surrounding captured image is an omnidirectional image.
(19)

An information processing method including:
by an information processing device,
performing control of spatial localization of an audio of another user except a target user on a basis of information regarding at least one of a view direction of a first user corresponding to a captured image captured by an imaging device provided for the first user or a view direction of a second user who views a surrounding captured image in which surroundings of a position where the first user exists are captured as the captured image.
(20)

A recording medium storing a program for causing a computer to function as a control unit configured to:
perform control of spatial localization of an audio of another user except a target user on a basis of information regarding at least one of a view direction of a first user corresponding to a captured image captured by an imaging device provided for the first user or a view direction of a second user who views a surrounding captured image in which surroundings of a position where the first user exists are captured as the captured image.

### REFERENCE SIGNS LIST

1 View information sharing system
10 Distribution device
20 Viewing device
30 Server
40 Network
100 Control unit
101 Input/output unit
102 Processing unit
103 Communication unit
111 Audio input unit
112 Imaging unit
113 Position and posture detection unit
114 Audio output unit
115 Image processing unit
116 Audio coordinate synchronization processing unit
117 Stereophonic sound rendering unit
118 Audio transmission unit
119 Image transmission unit
120 Position and posture transmission unit
121 Audio reception unit
122 Position and posture reception unit
200 Control unit
201 Input/output unit
202 Processing unit
203 Communication unit
211 Audio input unit
212 Image display unit
213 Position and posture detection unit
214 Audio output unit
215 Image processing unit
216 Audio coordinate synchronization processing unit
217 Stereophonic sound rendering unit
218 Audio transmission unit
219 Image reception unit
220 Position and posture transmission unit
221 Audio reception unit
222 Position and posture reception unit
300 Control unit
301 Communication unit
302 Processing unit
311 Image processing unit
312 Audio coordinate synchronization processing unit
313 Stereophonic sound rendering unit
601 Audio processing unit
611 Sound pressure amplification unit
612 EQ filter unit
613 Reverb unit
614 Stereophonic sound processing unit
615 Mixer unit
616 A11-sound common space/distance reverb unit
1001 CPU

1. An information processing device comprising:
a control unit configured to
perform control of spatial localization of an audio of another user except a target user on a basis of information regarding at least one of a view direction of a first user corresponding to a captured image captured by an imaging device provided for the first user or a view direction of a second user who views a surrounding captured image in which surroundings of a position where the first user exists are captured as the captured image.

2. The information processing device according to claim 1, wherein,
in a case where the target user is the first user and the another user is the second user, when a change in the view direction of the first user is detected, the control unit rotationally corrects the surrounding captured image and the audio of the second user in a direction of offset in accordance with a rotation amount according to the detected change in the view direction of the first user.

3. The information processing device according to claim 2, wherein,
when a change in the view direction of the second user is detected, the control unit rotationally corrects the audio of the second user in accordance with a rotation amount according to the detected change in the view direction of the second user.

4. The information processing device according to claim 1, wherein,
in a case where the target user is the second user and the another user is the first user, when a change in the view direction of the first user is detected, the control unit rotationally corrects the audio of the first user in accordance with a rotation amount according to the detected change in the view direction of the first user.

5. The information processing device according to claim 4, wherein,
when a change in the view direction of the second user is detected, the control unit rotationally corrects the audio of the first user in a direction of offset in accordance with a rotation amount according to the detected change in the view direction of the second user.

6. The information processing device according to claim 1, wherein,
in a case where the target user is the second user and the another user is another second user different from the second user, when a change in the view direction of the second user is detected, the control unit rotationally corrects the audio of the another second user in a direction of offset in accordance with a rotation amount according to the detected change in the view direction of the second user.

7. The information processing device according to claim 6, wherein,
when a change in the view direction of the another second user is detected, the control unit rotationally corrects the audio of the another second user in accordance with a rotation amount according to the detected change in the view direction of the another second user.

8. The information processing device according to claim 1, wherein
the control unit controls the spatial localization of the audio of the another user in a depth direction on a basis of a distance in the depth direction of an object in a field of view of each of the first user and the second user.

9. The information processing device according to claim 1, wherein
the control unit specifies an attention point of the another user and fixes a localization direction of the audio of the another user to the specified attention point.

10. The information processing device according to claim 1, further comprising:
an audio processing unit configured to perform processing of adjusting the audio of the another user.

11. The information processing device according to claim 10, wherein
the audio processing unit adjusts the audio of the another user on a basis of importance of the audio of the another user and an attribute of the audio.

12. The information processing device according to claim 11, wherein
the audio processing unit performs processing of dynamically adjusting at least one of a sound pressure, an equalizer (EQ), a reverb, or the spatial localization between the audios of the other users.

13. The information processing device according to claim 12, wherein
the audio processing unit adjusts the audio of each of the other users on a basis of a relationship between the other users.

14. The information processing device according to claim 10, wherein
the audio processing unit adjusts the spatial localization of a line-of-sight guidance sound for guiding a line-of-sight of the target user.

15. The information processing device according to claim 10, wherein
the audio processing unit adjusts spatial localization of a virtual stationary sound corresponding to the another user with respect to the target user.

16. The information processing device according to claim 1, wherein
the control unit controls the spatial localization of the audio of the another user in a depth direction on a basis of priorities of the first user and the second user.

17. The information processing device according to claim 1, wherein,
in a case where the target user is the first user and the another user is the second user, when there is a plurality of the second users, the control unit divides the second users into specific groups and divides the spatial localization of the audio for each of the specific groups.

18. The information processing device according to claim 1, wherein
the surrounding captured image is an omnidirectional image.

19. An information processing method comprising:
by an information processing device,
performing control of spatial localization of an audio of another user except a target user on a basis of information regarding at least one of a view direction of a first user corresponding to a captured image captured by an imaging device provided for the first user or a view direction of a second user who views a surrounding captured image in which surroundings of a position where the first user exists are captured as the captured image.

20. A recording medium storing a program for causing a computer to function as a control unit configured to:
perform control of spatial localization of an audio of another user except a target user on a basis of information regarding at least one of a view direction of a first user corresponding to a captured image captured by an imaging device provided for the first user or a view direction of a second user who views a surrounding captured image in which surroundings of a position where the first user exists are captured as the captured image.
